(19) United States
(12) Patent Application Publication
(10) Pub. No.: US 2013/0300101 A1
(43) Pub. Date: Nov. 14, 2013

(54) Laminated Documents and Cards Including Embedded Security Features

(71) Applicant: Document Security Systems, Inc., Rochester, NY (US)

(72) Inventors: David Wicker, Dansville, NY (US); Kenneth Wicker, Honeoye Falls, NY (US); Michael Caton, Oakfield, NY (US); Gary Andrechak, South San Francisco, CA (US); Jaeson Caulley, Foster City, CA (US); Michael Caulley, Foster City, CA (US); Phieu Luong, San Francisco, CA (US)

(21) Appl. No.: 13/839,461

(22) Filed: Mar. 15, 2013

Related U.S. Application Data
(60) Provisional application No. 61/645,942, filed on May 11, 2012.

(51) Int. Cl. B42D 15/00

(52) U.S. Cl. CPC B42D 15/00
USPC 283/67; 283/85

(57) ABSTRACT

An anti-counterfeit feature for a multi-layer document or plastic laminated card is provided according to some embodiments. The laminated card can include an embedded layer including a radio frequency radiation absorbing or deflecting material. The card can be authenticated by detecting an absence or a modification of a radio frequency signal due to the card interfering with a radiation source. The laminated card can also include a pattern of perforations passing partially or fully through one or more layers of the card so as to produce an effect similar to a watermark in the assembled laminated card by giving the card a modified transparency in a pattern associated with the pattern of perforations. The card can be authenticated by observing a pattern of light through the perforations.

### CROSS-REFERENCE TO RELATED APPLICATIONS

This application claims priority to, and the benefit of, U.S. Provisional Patent Application No. 61/645,942, filed May 11, 2012, the content of which is hereby incorporated herein by reference in its entirety.

### FIELD

The present disclosure generally relates to an anti-counterfeiting feature for a laminated card or other authenticated document and methods for producing such documents, and more particularly, to documents with embedded perforations or embedded radiation-absorbing material that verify the authenticity of the document.

### BACKGROUND

Unless otherwise indicated herein, the materials described in this section are not prior art to the claims in this application and are not admitted to be prior art by inclusion in this section.

Identification and transaction cards are typically made from a stack of laminated polyvinyl chloride (PVC) or other polymer layers. Some cards may include one or more anti-counterfeiting security features. Print based anti-counterfeiting methods rely on the difficulty of detecting the print, reproducing the print, or a combination of both. Ultraviolet inks are invisible to the unaided eye and are only visible under ultraviolet light. Microfine printing is very small, on the order of 2 to 4 points. Guilloche patterns are complex interwoven lines based on mathematical formula that are difficult to reproduce. Color-shifting inks appear as different colors according to angle of reflected lighting the viewer perceives. Some security inks contain ascertainable quantities of DNA in a predetermined gene sequence included in the ink to allow for later authentication of the ink by verifying the DNA gene sequence.

Still other security features are embedded in documents such as official and/or valuable documents by incorporating security features in the documents that are modified upon reproducing the document to thereby inhibit unauthorized copies of the documents from being made. Such security features can include latent features that are largely indistinguishable within the background of the document on an original, but which become distinguishable in a reproduction of the document such as in a scanned reproduction of the document. By embedding features that distinguish an original document from reproductions thereof, counterfeit versions and other unauthorized copies can be more readily detected. Thus, such documents including embedded security features offer an indicator of authenticity to ensure that a particular printed version of the document is an original.

Radio Frequency Identification (“RFID”) is a technology employed to detect characteristic identifying signals from an embedded integrated circuit or chip in a material or product tagged with the chip. The chip emits characteristic signals to provide verification after receiving a query signal from source. Such RFID embedded chips are included in some passports, credit cards, and inventory control systems, for example. To combat the potential for identity theft by reading outputs from such RFID devices, envelopes and sleeves that incorporate RFID shielding have been developed. RFID devices can be stored inside the envelopes and sleeves to prevent a nearby RFID reader from harvesting information from the RFID devices without the owner's knowledge or consent.

### SUMMARY

Aspects of the present disclosure generally provide embedded security features for multi-layer secured documents and laminated cards. In some embodiments of the present disclosure, embedded security features are situated in an inner layer or inner core of a secured document or card and allow for verifying the document as authentic on the basis of the internal embedded security feature. In some embodiments, the security feature is a radiation-interfering material that selectively blocks, reflects, interferes with, or otherwise alters incident radiation in such a way that the alteration in the radiation is recognizable/detectable by a receiver. In some embodiments, the embedded security feature includes internal regions of the document or card with variable transparency/opacity such that light is selectively transmitted through the card to reveal an embedded watermark-like feature in the document or card. In some embodiments, the selective transparency/opacity of the document or card can be achieved by a pattern of perforations in an internal core, by varying a thickness of an internal core, and/or by selectively applying ink or other similar materials to an inner surface of the multi-layer document or card. In some embodiments, the embedded security feature is a chemical or photo-activated taggant material that is embedded in an inner layer that emits visible light when exposed to UV and/or IR light. In some embodiments, the embedded security feature is an internally integrated metallic and/or magnetic substance configured to activate a metal detector.

The present disclosure includes descriptions of secured documents and secured cards that have multiple layers and are stacked together by an adhesive and/or by laminating the layers together by applying heat and/or pressure. While some particular examples or such documents are disclosed herein, such as identification cards, passports, etc., it is noted that aspects of the present disclosure apply to various documents/cards having value or which are desired to be authentic, such as the following non-limiting examples: social security cards, birth certificates, bills of sale, titles, deeds, currency, checks, bonds, certificates, diplomas, transcripts, bearer instruments, contracts, assignments, agreements, identity cards, credit cards, passports, documents affecting ownership of property, documents establishing an identity, any documents for which anti-counterfeiting techniques are employed, and other documents which are desired to be verifiable as authentic.

In some embodiments of the present disclosure, a method of authenticating a secured document is provided. The method can include transmitting radiation from an emitter to a detector; situating the secured document such that a conductive material embedded in the secured document interferes with the transmitted radiation; and detecting a modification of the transmitted radiation at the detector, due to the interference by the secured document, to thereby verify an authenticity of the secured document. The secured document can be situated proximate the emitter, or along a radiative path between the emitter and the detector.

In some embodiments of the present disclosure, a multi-layer secured card is provided. The multi-layer secured card can include an inner layer, a first outer layer, and a second outer layer. The inner layer can include a conductive material configured to interfere with incident radiation such that a modification in the incident radiation is observable. The first and second outer layers can be situated on opposing sides of the inner layer so as to surround the inner layer.

In some embodiments of the present disclosure, a system for authenticating a secured document is provided. The system can include an emitting antenna for emitting radio frequency radiation; a receiving antenna for detecting the emitted radiation from the emitting antenna and producing signals indicative of the detected radiation; and a controller for receiving the signals from the receiving antenna and dynamically detecting a modification in the received radiation to determine whether the modification in received radiation corresponds to a radiation modification profile associated with an authenticated document.

In some embodiments of the present disclosure, a method of producing a multi-layer secured card is provided. The method can include perforating through an inner layer according to a perforation pattern, and securely coupling the inner layer to a first and a second outer layer on opposing surfaces of the inner layer so as to surround the inner layer. The transparency of the inner layer can differ from a transparency of at least one of the first or second layers such that a distinguishable pattern corresponding to the perforations pattern is revealed in response to light transmission through the card.

In some embodiments of the present disclosure, a method of producing a multi-layer secured card is provided. The method can include depositing material to form an inner layer according to a pattern including apertures; and securely coupling the inner layer to a first and a second outer layer on opposing surfaces of the inner layer so as to surround the inner layer. The transparency of the inner layer differs from a transparency of at least one of the first or second layers such that a distinguishable pattern corresponding to the pattern is revealed in response to light transmission through the card.

In some embodiments of the present disclosure, a multi-layer secured card is provided. The multi-layer secured card can include an inner layer, a first layer, and a second layer. The inner layer can have a pattern of perforations through the inner layer. The first and second layers can be situated on opposing surfaces of the inner layer so as to surround the inner layer. The first, second, and inner layers can be securely coupled to one another. A verification pattern corresponding to the pattern of perforations can be distinguishable in response to incident light being reflected from, or transmitted through, the secured card.

In some embodiments of the present disclosure, a multi-layer secured card is provided. The multi-layer secured card can include an inner layer, a first outer layer, and a second outer layer. The inner layer can include a metallic or magnetic material in an amount sufficient to activate an industrial metal detector. The first and second outer layers can be situated on opposing surfaces of the inner layer so as to surround the inner layer. The first, second, and inner layers can be securely coupled to one another. A verification pattern corresponding to the pattern of perforations can be distinguishable in response to incident light being reflected from, or transmitted through, the secured card.

In some embodiments of the present disclosure, a secured card is provided. The secured card can include a first and a second layer securely coupled to one another along respective inner surfaces of the first and second layers; and a taggant applied to at least one of the inner surfaces of the first and second layers. The taggant can be arranged in a verification pattern, the taggant can be configured to radiate energy to reveal the verification pattern in response to being activated by radiatively received activation energy.

In some embodiments of the present disclosure, a multi-layer secured card is provided. The multi-layer secured card can include an inner layer including a region of variable opacity defining a line-screen pattern of opacity, the region including a latent image in an integrated background setting. The latent image can be substantially indistinguishable to the unaided eye, but can become distinguishable via moire interference patterns generated by an overlaid visual aid having a spatial frequency configured to selectively interfere with at least one of the background or the latent image.

In some examples, a multi-layered secured card may include a latent image formed by a pattern of variable opacity in an inner layer, which is distinguishable through use of a visual aid. The latent image (defined by the pattern of variable opacity) may form circles or other shapes, line-screen patterns, and/or may include characters such as numbers or letters. Moreover, such characters may even be recognized by an optical character recognition technique. In some examples, the visual aid can be a lens with a pattern of variable opacity at a spatial frequency that corresponds to the pattern of variable opacity in the multi-layer card. When such a lens is overlaid, the latent image can be distinguishable from its background due to, for example, preferentially transmitting light corresponding to one or the other. Moreover, the visual aid may include a smart device, such as a camera-equipped mobile phone, tablet, another computing device, etc. The smart device may include, and/or be in communication with: a camera, a processing system, and an electronically controlled display or another user-interface output (e.g., speakers, haptic feedback system, etc.). Such a smart device may then capture an image of the multi-layer card (and the latent image therein) process the resulting image to identify the latent image, and then provide an indication of the identification results, such as by displaying an indication of such results. Thus, a user can use a camera-equipped smart device to verify the presence of a security feature in a particular multi-layer card, and thereby authenticate such card.

These as well as other aspects, advantages, and alternatives, will become apparent to those of ordinary skill in the art by reading the following detailed description, with reference where appropriate to the accompanying drawings.

### BRIEF DESCRIPTION OF THE DRAWINGS

The foregoing and other advantages of the disclosure will become apparent upon reading the following detailed description and upon reference to the drawings.

FIG. 1A is a radio frequency identification (“RFID”) system configured for use in an authentication and verification system according to the present disclosure.

FIG. 1B is a radio frequency identification system situated as an authentication and verification system to verify the authenticity of a secured card.

FIG. 1C is another configuration of the authentication and verification system shown in FIG. 1B situated to verify the authenticity of the secured card.

FIG. 2A is an exploded view of the multiple layers of the laminated secured card according to some embodiments.

FIG. 2B is a top view of the secured card illustrating that the exterior layers of the laminated secured card can be larger than the interior layer so as to envelope the interior layer according to some embodiments.

FIG. 3A is a side cross-section view of the interior layer of the secured card when the interior layer is a substantially uniform sheet of radiation absorbing or deflecting conductive material.

FIG. 3B is a side cross-section view of another interior layer of the secured card when the interior layer includes embedded conductive particles embedded to provide radiation absorption and/or deflection.

FIG. 3C is a side cross-section view of another interior layer of the secured card when the interior layer includes a conductive sheet adhered to a polymeric substrate to provide radiation absorption and/or deflection.

FIG. 3D is a side cross-section view of another interior layer of the secured card when the interior layer includes two sheets of conductive material sandwiched around a polymeric substrate to provide radiation absorption and/or deflection.

FIG. 4A is a top view of an interior layer of the secured card when the interior layer includes a radiation shielding conductive material with one or more slits passing through to create a grating suitable for interfering with radiation.

FIG. 4B is a top view of another interior layer of the secured card when the interior layer includes a radiation shielding conductive material with one or more holes passing through to create a grating suitable for interfering with incoming radiation.

FIG. 4C is a top view of another interior layer of the secured card when the interior layer includes a radiation shielding conductive material with one or more perforations passing through and arranged in a pattern of alphanumeric characters.

FIG. 5A is a block diagram of the verification systems of FIGS. 1A to 1C attached to a processor suitable for detecting and interpreting a signal from the RFID tag in the absence of the secured card.

FIG. 5B is a block diagram of the verification system shown in FIG. 5A with the secured card intentionally interfering with the radiation and thereby causing the processor to fail to recognize the signal from the RFID tag

FIG. 5C is a flowchart for verifying an authenticity of a secured card by causing an RFID detection system to fail to detect signals due to absorption of the signals by the secured card.

FIG. 5D is a flowchart for verifying an authenticity of a secured card by observing characteristic modifications of an RFID signal due to alterations of the signals by the secured card.

FIG. 6A is an example power spectrum of the received RFID signal in the absence of interference from the secured card.

FIG. 6B is an example power spectrum of received the received RFID signal after alterations of the signals by the secured card.

FIG. 7A is a side cross-sectional view of a three-layer secured card including a perforated inner core and transparent regions of the outer layers providing an angled light passage security feature.

FIG. 7B is a side cross-sectional view of another three-layer secured card including a perforated inner core with an angled perforation and transparent regions of the outer layers providing an angled light passage security feature.

FIG. 7C is a side cross-sectional view of another three-layer secured card including a perforated inner core and perforations in the outer layers providing an angled light passage security feature.

FIG. 7D is a side cross-sectional view of another three-layer secured card including perforated inner core with multiple apertures and transparent regions of the outer layers providing multiple angled light passage security feature.

FIG. 7E is a side cross-sectional view of another three-layer secured card including a perforated inner core with multiple apertures and transparent regions of the outer layers providing multiple angled light passage security features at distinct angles.

FIG. 7F is a side cross-sectional view of another three-layer secured card including a perforated inner core with multiple apertures and transparent regions of the outer layers providing an angled light passage security feature with multiple light paths through a single transparent region.

FIG. 7G is a side cross-sectional view of a two-layer secured card including transparent regions of the outer layers positioned to provide an angled light passage security feature.

FIG. 8A is an aspect view of a partially cut-away three-layer secured card with a printed face on one side and a region of variable transparency in the inner core that is configured to provide an embedded water mark corresponding to the printed face.

FIG. 8B is a diagram of an observer viewing the variable transparency through the secured card to authenticate the card.

FIG. 8C is a diagram of an observer viewing the variable transparency through the card by observing a pattern on a screen to authenticate the card.

FIG. 9A is an exploded view of a two-layer secured document including taggant materials on an inner surface of the assembled card such that the taggant materials are embedded within the card.

FIG. 9B is a diagram of the taggant particles disposed on the inner surface of the card that emit visible light in response to exposure with UV light.

FIG. 9C is a diagram of a two layer secured document constructed by folding over a single sheet so as to enclose taggant materials printed on an inner surface of the folded sheet.

FIG. 10A is an aspect view of a multi-layer secured card with an inner layer configured as a lens with striated variable transparency providing a latent image embedded in a background setting.

FIG. 10B is a side cross-sectional view of a three-layer secured card including the inner layer with striated variable transparency provided by variable thickness in the inner layer.

FIG. 10C is a top view of the assembled secured card shown in FIG. 10A where the latent image is revealed by a viewing aid situated over the card.

FIG. 11 is an exploded view of a three-layer card with an inner layer including a metallic and/or magnetic material sufficient to activate a metal detector.

### DETAILED DESCRIPTION

Aspects of the present disclosure generally provide embedded security features for multi-layer secured documents and laminated cards. In some embodiments of the present disclosure, embedded security features are situated in an inner layer or inner core of a secured document or card and allow for verifying the document as authentic on the basis of the internal embedded security feature. In some embodiments, the security feature is a radiation-interfering material that selectively blocks, reflects, interferes with, or otherwise alters incident radiation in such a way that the alteration in the radiation is recognizable/detectable by a receiver. In some embodiments, the embedded security feature includes internal regions of the document or card with variable transparency/opacity such that light is selectively transmitted through the card to reveal an embedded watermark-like feature in the document or card. In some embodiments, the selective transparency/opacity of the document or card can be achieved by a pattern of perforations in an internal core, by varying a thickness of an internal core, and/or by selectively applying ink or other similar materials to an inner surface of the multi-layer document or card. In some embodiments, the embedded security feature is a chemical or photo-activated taggant material that is embedded in an inner layer that emits visible light when exposed to UV and/or IR light. In some embodiments, the embedded security feature is an internally integrated metallic and/or magnetic substance configured to activate a metal detector.

The present disclosure includes descriptions of secured documents and secured cards that have multiple layers and are stacked together by an adhesive and/or by laminating the layers together by applying heat and/or pressure. While some particular examples or such documents are disclosed herein, such as identification cards, passports, etc., it is noted that aspects of the present disclosure apply to various documents/cards having value or which are desired to be authentic, such as the following non-limiting examples: social security cards, birth certificates, bills of sale, titles, deeds, currency, checks, bonds, certificates, diplomas, transcripts, bearer instruments, contracts, assignments, agreements, identity cards, credit cards, passports, documents affecting ownership of property, documents establishing an identity, any documents for which anti-counterfeiting techniques are employed, and other documents which are desired to be verifiable as authentic.

The anti-counterfeiting features can include a printed feature or applied feature, such as a printed security feature or an applied holographic foil, placed on a layer. Some features can include an image embossed or debossed, and either single or dual-die stamped into a layer. Embossing produces an image (graphic or alphanumeric text) that is raised above the surface of the layer. Debossing produces an image is pressed into the layer and appears below the surface. Blind embossing and blind debossing are the processes of embossing or debossing, respectively, an image that is the same color as the layer. Holograms can be applied to the document or card or integrated in a transparent outer layer. For example, specially marked aluminum foils (holograms) can be placed on an outer layer of the card and secured in place by laminating the foil to the card (applying heat and pressure) and/or using adhesive. A hologram image can be embossed on a transparent hologram security laminate configured as a pouch to hold the inner layers of the card. The card is then sealed inside the pouch resulting in the hologram laminate forming the outer layer of the card. An optional destruct feature occurs during an attempt to remove the outer laminate even if the counterfeiter tries to reposition the laminate on another card or in its original place. Furthermore, some security features can include embedded RFID chips in cards that are verified as authentic when the card emits a characteristic signal from its embedded chip.

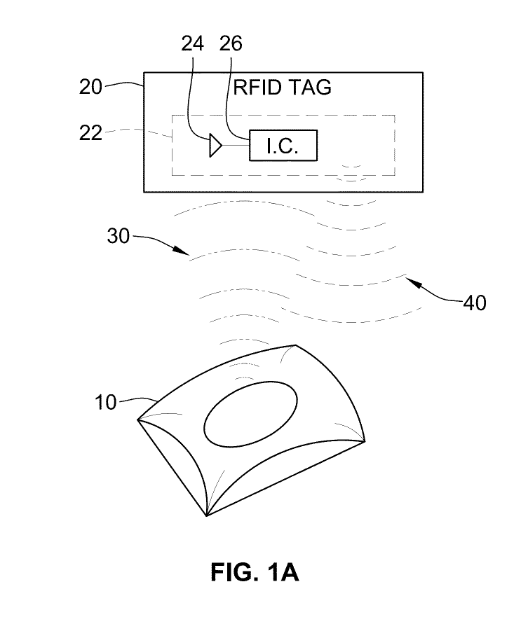

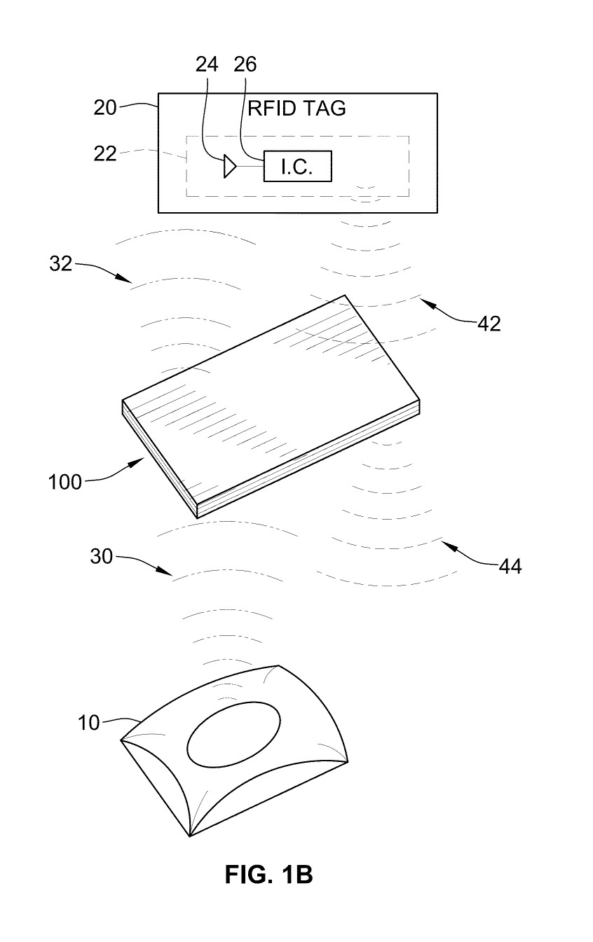

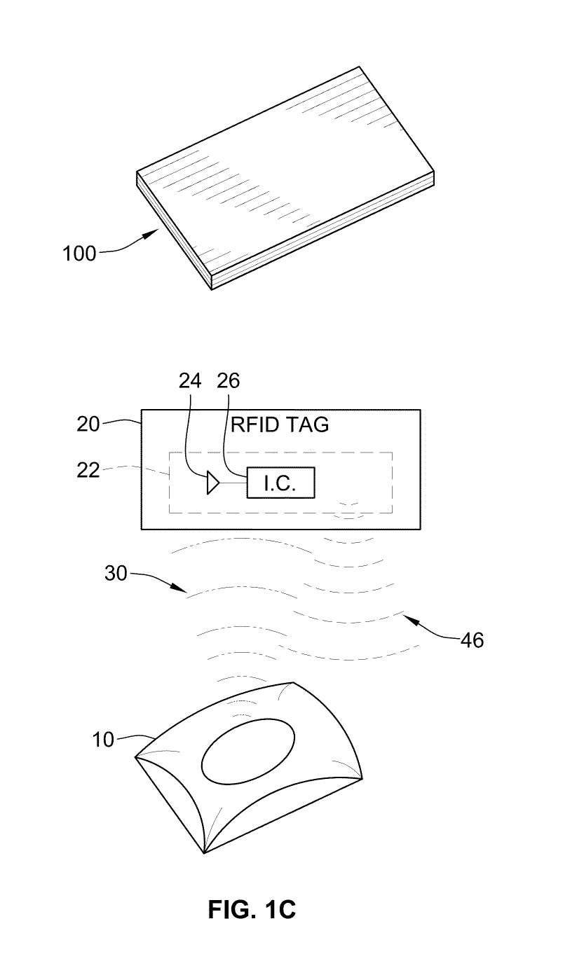

FIG. 1A is a radio frequency identification (“RFID”) system configured for use in an authentication and verification system according to the present disclosure. The RFID system includes a transmitter/receiver module 10 (“transceiver”) and an RFID tag 20. The transmitter/receiver module 10 may be alternately referred to generally and herein as an interrogator. In some embodiments, the transceiver 10 can be a desktop device suitable for both generating emitted radiation 30, and detecting responsive radiation 40. Thus, the transceiver 10 can include both an emitting antenna and a receiving antenna (e.g., a bistatic interrogator), or can include a single antenna performing both functions at temporally separated intervals (e.g., a monostatic interrogator). In some embodiments, the transceiver 10 can be two separate devices, one of which generates the emitted radiation 30, the other of which detects the responsive radiation 40.

The RFID tag 20 is a device configured to emit the responsive radiation 40 in response to receiving the radiation 30 emitted from the transceiver 10. The RFID tag 20 includes a communication module 22 that includes, generally, an antenna portion 24, and an integrated circuit 26 (“I.C.” or “chip”) that regulates the operation of the antenna portion 24 in response to energy received. In some examples, where the RFID tag 20 is a passive device and not actively driven by an external power source, the integrated circuit 26 can include capacitive and/or inductive elements for harvesting energy via the antenna portion 24 to power the operation of the I.C. 26 during subsequent emission. In some examples, the RFID tag 20 is operated in alternating intervals of reception and transmission. During the reception phase, the antenna 24 and the I.C. 26 receive power from incoming radio frequency signals, and during a subsequent transmission phase, the antenna 24 and the I.C. 26 operate to transmit signals in response to the received signals, if any. In other examples, the RFID tag 20 can be an active device with an external power supply, such as, e.g., a battery, to power amplifiers, filters, etc., to provide signal conditioning and/or boost signal gain in the responsive radiation 40 received at the transceiver 10.

In addition, the integrated circuit 26 can be configured to operate the antenna portion 24 to embed characteristic information in the radiation 40 sufficient to uniquely identify the RFID tag 20. For example, the received radiation 40 can include an encoded series of data bits, which can be decoded by a controller or processor associated with the transceiver 10. In some examples, the embedded signals can be unique or substantially unique to the RFID tag 20 to allow the RFID tag 20 to be distinguished from other RFID tags, such as where RFID tags are used to monitor inventory and each “tagged” item in an inventory is associated with a tag having a unique response signal.

The RFID system shown in FIG. 1A can be operated according to a query and response operation scheme where the emitted radiation 30 is conveyed from the transceiver 10 and received at the RFID tag 20 via the communication module 22. The RFID tag 20 harvests energy from the transmitted radiation 30 to power inductive components in the integrated circuit 26 and provide signals to the antenna portion 24 including information substantially distinctive of the RFID tag 20. The antenna portion 24 generates the radiation 40 according to the embedded data and the transceiver 10 detects the radiation 40. Signal processing elements within the transceiver 10 or in an associated controller retrieve the embedded data to identify the RFID tag 20 as the one associated with the received embedded data. Thus, the transmitted radiation 30 from the transceiver 10 can be considered a query signal to the RFID tag 20 and the radiation 40 emitted from the RFID tag 20 in response can be considered a response signal that identifies the RFID tag 20 as the one associated with the embedded data encoded according to the integrated circuit 26.

Systems similar to the one shown in FIG. 1A and functional equivalents thereof can be employed to identify various RFID “tagged” items passing within a particular range of such transceivers. For example, inventory control systems can be operated to identify items coming or going into or out of particular warehouses, store rooms, etc. In other instances, credit cards, passports, identification cards, etc., can include additional embedded information in an RFID chip memory (e.g., in the integrated circuit 26) and the information can be retrievable via an RFID system. Furthermore, in some embodiments, one or more aspects of the transceiver 10 may be included in a mobile device, a tablet, and/or another computing device including an antenna with a suitable chipset and processing system. For instance, a mobile phone equipped to communicate RFID signals (or another suitable signaling protocol such as near field communication (NFC) and the like) may be used to interrogate a secured card with embedded radiation-interfering and/or radiation-absorbing materials.

In some aspects of the present disclosure, however, the system shown in FIG. 1A can be a system for verifying a secured document's authenticity by detecting the presence of embedded materials within the secured document. For example, particular materials can be included in an inner layer of a multi-layer laminated card to wholly or partially absorb, or otherwise alter, radio frequency signals incident on the card. Detecting modifications in the signals received at the transceiver 10 can thus be an indicator that the signals were influenced or modified by a secured document including the embedded materials. In some examples provided herein, failing to observe the responsive radiation 40 at the transceiver 10 (e.g., detecting an absence of the responsive radiation 40 and/or failing to distinguish the responsive radiation 40 from background noise) can be an indicator that a secured document situated between the RFID tag 20 and the transceiver 10 includes the embedded materials.

In some examples, the responsive radiation 40 can be detected, but is subject to sufficient interference to prevent the reconstruction of the encoded data within the responsive radiation 40, and the failure to decode the encoded data via the transceiver 10 and/or associated signal processing equipment can be an indicator that the responsive radiation 40 was subjected to intentional interference by a secured document including embedded materials indicative of its authenticity. In some embodiments, the intentional interference in the responsive radiation 40 via embedded interfering materials in a secured card can be distinguished from incidental and/or environmental background interference in the responsive radiation, such as due to environmental factors, humidity, proximate objects including radio frequency interfering materials, such as vessels containing water or other fluids, metallic objects, etc. It is recognized that most radiation environments include at least some sources of noise and/or scattering, redirecting, and/or absorbing surfaces. However, some embodiments of the present disclosure provide for intentionally influencing RFID signals via embedded radiation-influencing materials in secured cards. Furthermore, some embodiments provide for arrangements where interference in RFID signals is performed in a systematic and/or characteristic manner that differs from typical interference generated by inadvertent sources of interferences, such as environmental noise, etc.

In the arrangement of FIG. 1A, where the responsive signals 40 arrive at the transceiver 10 unimpeded by interfering materials (such as materials embedded in a secured document), detecting the responsive signals 40 and/or successfully decoding the embedded information can be considered an indication of an absence of radiation absorbing and/or modifying materials. Thus, in some embodiments, successfully detecting the responsive radiation 40 and/or retrieving the embedded data can indicate an unauthentic document by indicating the absence of radiation interfering materials within the document. Furthermore, in some embodiments, failing to detect the responsive radiation 40, detecting a modification in the responsive radiation 40, and/or failing to successfully decode the data embedded in the received radiation can indicate an authentic document by indicating the presence of radiation interfering materials within the document.

In other examples of the system shown in FIG. 1A, the transceiver 10 can be replaced with a receiving module and the RFID tag 20 can be a transmitter configured to generate radio frequency radiation and direct the radiation toward an associated receiving module. Thus, aspects of the present disclosure apply to functionally similar systems that lack the emitted radiation 30 from the transceiver 10, and where the responsive radiation 40 transmitted from the RFID tag 20 to the transceiver 10 is generated substantially independent of a “query” signal from the transceiver 10. In some embodiments, the RFID tag 20 (or equivalent signal generator) can continuously or substantially continuously operate to generate the responsive radiation 40 to be received and/or processed at the transceiver 10 and associated processing systems.

Exemplary arrangements for situating a secured document, such as an identity card, with respect to the transceiver 10 and the RFID tag 20 to test its authenticity (e.g., by determining whether the document includes radiation-influencing materials) are illustrated and described in connection with FIGS. 1B and 1C herein.

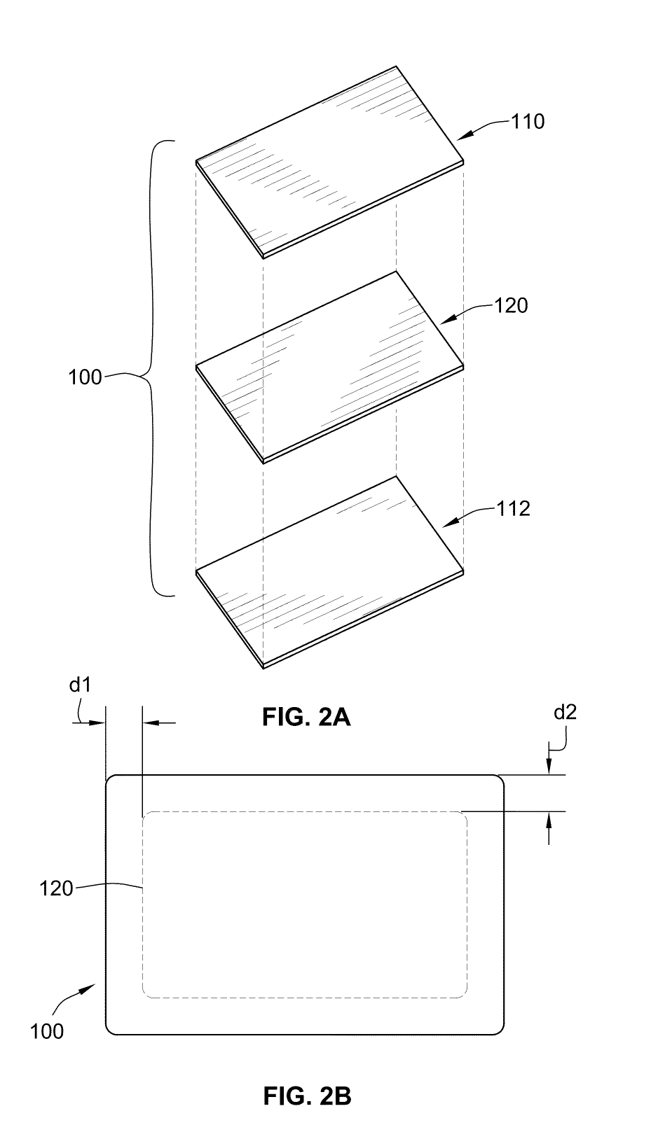

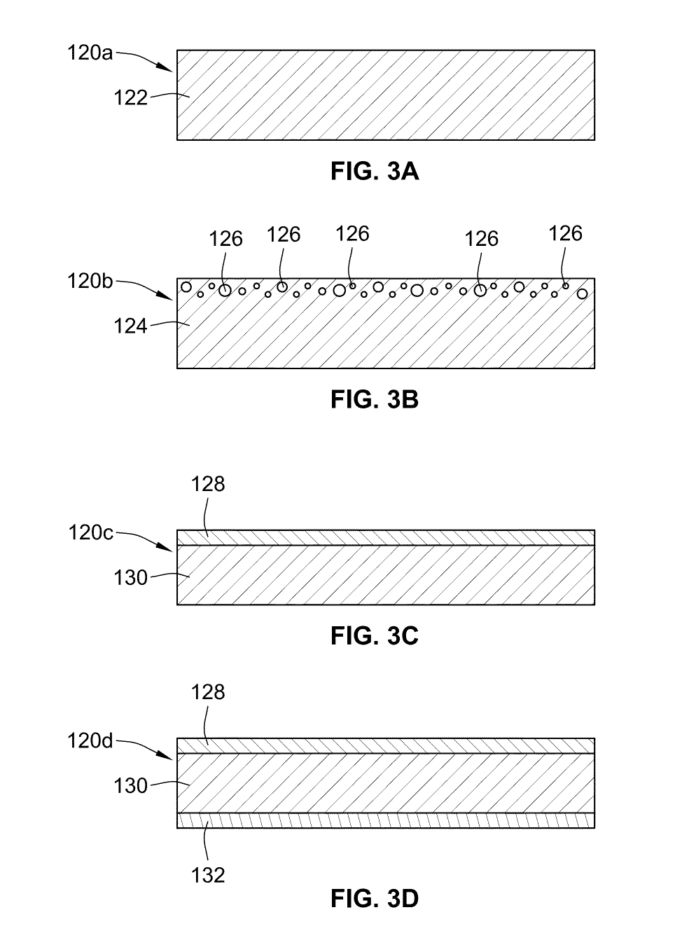

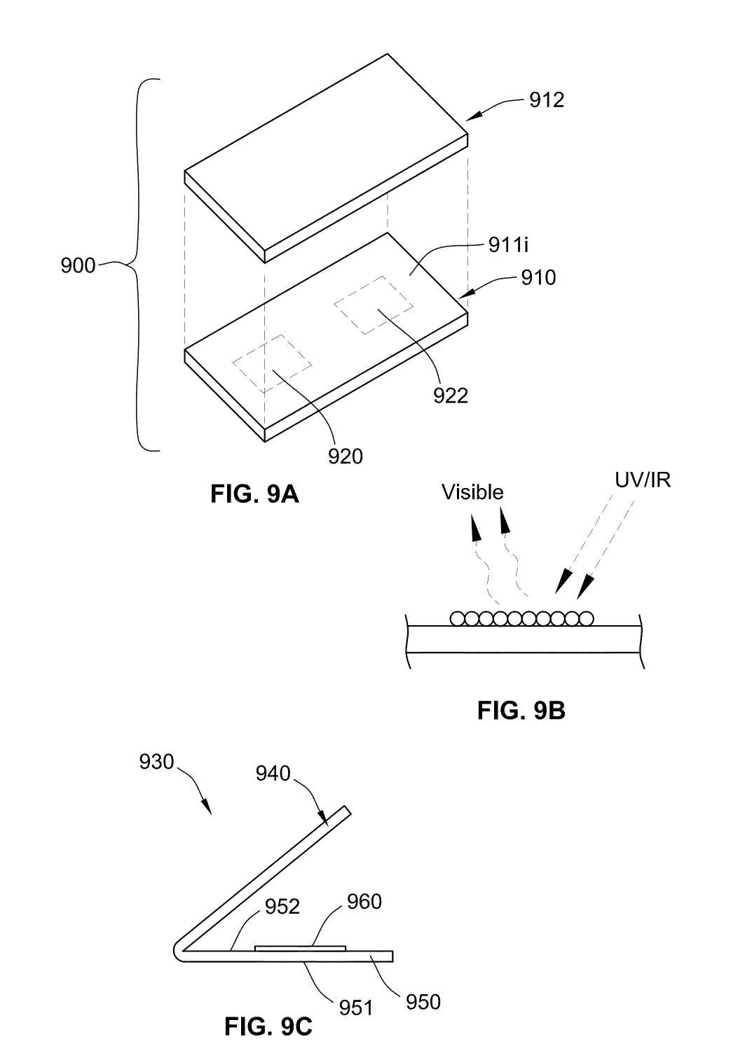

FIG. 1B is a radio frequency identification system situated as an authentication and verification system to verify the authenticity of a secured card 100. The secured card 100 is one example of a secured document including a conductive layer for influencing radiation incident on the secured card 100. The secured card 100 can be a multi-layer laminated card including polymeric materials such as, for example, PVC, PET, ABS, polycarbonate, combinations of these, etc. The secured card 100 can be sized to have dimensions similar to a typical driver's license, official state identification document, passport, or similar identification document. Thus, aspects of the present disclosure may be employed to create documents with embedded security features. For example, documents such as building permits, parking placards, tickets, and other documents associated with a monetary value, etc. may employ embedded security features similar to those described herein in the context of secured “cards.” Such documents may include two (or more) layers, such as one layer formed of a substrate with radiation interfering and/or absorbing materials and a single-sided laminated material. For instance, a substrate such as a building permit, ticket, boarding pass, drivers license, etc., may be created from a single-layered document bearing printing which is then face laminated (e.g., by applying a polymeric material to a single face of the document). Examples of the structure of the multi-layer secured card 100 (or secured document) will be described in connection with FIGS. 2-3 below, and also in connection with FIG. 9.

In an exemplary operation of the system shown in FIG. 1B, the authenticity of the secured card 100 can be verified by determining that the secured card includes materials for modifying radiation incident on the secured card 100. The secured card 100 is placed between the transceiver 10 and the RFID tag 20 so as to interfere with the emitted radiation 30 from the transceiver 10. In some embodiments, the secured card 100 is placed between the transceiver 10 and the RFID tag 20 so as to intentionally interfere with the emitted radiation 30 from the transceiver 10. In some embodiments, the secured card 100 is placed along a radiative path between the transceiver 10 and the RFID tag 20, which can be a path determined according to reflecting/absorbing surfaces and surroundings. The emitted radiation 30 is wholly or partially absorbed and/or re-directed by the secured card 100 and a transmitted portion 32 continues on to the RFID tag 20. Depending on the amount and distribution of conductive material in the secured card 100, and the orientation and/or position of the secured card 100, the transmitted portion 32 may be negligible (e.g., where the emitted radiation 30 is substantially blocked, absorbed, and/or redirected away from the RFID tag 20). In some examples, the transmitted portion 32 of the emitted radiation 30 continues on to the RFID tag 20 to cause the RFID tag 20 to emit a response signal 42.

The response signal 42 can have a reduced signal strength because the power of the response signal 42 is based on harvested energy from the partially transmitted portion 32 of the emitted radiation 30. The response signal 42 is transmitted from the RFID tag 20 toward the transceiver 10. The secured card 100 interferes with the response signal 42 via its embedded conductive materials and a partially transmitted response signal 44 may continue on to the transceiver 10. In some embodiments, the interference with the response signal via the secured card 100 is intentional. In some embodiments, the partially transmitted response signal 44 is negligible due to the response signal 42 being substantially blocked, absorbed, and/or redirected away from the transceiver 10. Generally, the intensity and/or frequency of the partially transmitted response signal 44 can depend on the amount and distribution of conductive material in the secured card 100, and the orientation and/or position of the secured card 100 with respect to the signals 42.

In some embodiments, the emitted radiation 30 is wholly or partially absorbed within the secured card 100 via the embedded conductive materials. In some embodiments the response signal 42 is wholly or partially absorbed within the secured card 100. In some embodiments, the radiation signals 30, 42 passing through the secured card 100 are at least partially redirected or partially blocked such that the respective transmitted portions 32, 44 are distinguishable from unimpeded signals. By distinguishing the partially transmitted response signal 44 from unimpeded received radiation 40 (FIG. 1A), the system shown in FIG. 1B can indicate whether the secured card 100 includes an embedded conductive material suitable for absorbing, blocking, deflecting, and/or redirecting radio frequency signals emitted from the RFID tag 20. In some embodiments, the transceiver 10 can be configured to detect reflected radiation that bounces off the secured card 100 and is directed back to the transceiver 10 without reaching the RFID tag 20. The reflected radiation can be characteristically recognizable via the transceiver 10 based on the distribution and/or amount of embedded radiation reflecting materials in the secured card 100.

Furthermore, the system shown in FIG. 1B can be operated to evaluate the authenticity of the secured card 100 according to changes in the radiation received at the transceiver 10. For example, when the secured card 100 is passed (“moved”) through the region between the transceiver 10 and the RFID tag 20, the signals received at the transceiver 10 can initially be relatively strong, followed by a dip as the radiation signals are substantially blocked/deflected via conductive materials in the card 100, and then return to a relatively strong signal level as the secured card 100 exits the radiative path between the transceiver 10 and the RFID tag 20. Forming determinations of authenticity based on the dynamic signature of the signals received at the transceiver 10 (and processed via associated signal processing equipment) can allow for a relatively more robust determination of authenticity that is less susceptible to false positives (e.g., where the system fails to detect signals from the RFID tag 20 due to external influences not associated with the presence of the secured card 100 in the radiative path). Additionally or alternatively, the system can be configured to determine whether a document includes radiation-influencing materials based on signatures (dynamic or absolute) of the embedded data signals in the radiation received at the transceiver 10.

FIG. 1C is another configuration of the authentication and verification system shown in FIG. 1B situated to verify the authenticity of the secured card. In the arrangement of FIG. 1C, the secured card 100 is placed near the RFID tag 20, but not in between the transceiver 10 and the RFID tag 20. By situating the secured card 100 near (“proximate”) the RFID tag 20, the field surrounding the communication module 22 of the RFID tag 20 is sufficiently altered that an altered response signal 46 emitted from the antenna portion 24 is distinguishable via the transceiver 10. In some examples, radiation from the RFID tag 20 is substantially absorbed within the secured card 100 rather than continuing to the transceiver 10.

In some embodiments, the secured card 100 can be placed in contact with the RFID tag 20 to produce the observed interference/alteration with the signals received at the transceiver 10. In some embodiments, the observed interference/alteration with the signals received at the transceiver 10 can be intentional. In some embodiments, the secured card 100 can be separated by a relatively short distance, such as, for example, 1-2 centimeters. In some examples, the amount of separation between the secured card 100 and the RFID tag 20 (and its associated antenna portion 24) is determined based on the amount and/or distribution of conductive material in the secured card 100 and its orientation and/or position with respect to the RFID tag 20, the wavelength of the radiation employed in the RFID system, and any other external features influencing the transmission of radiation in the vicinity of the RFID tag 20 and/or transceiver 10.

In some examples of the systems shown in FIGS. 1A-1C, the RFID tag 20 can be separated from the transceiver 10 by a short distance, such as, for example 20 cm to 1 meter, to allow for a region where documents can be passed between the two for evaluating the authenticity of the documents. The region between the transceiver 10 and the RFID tag 20 can be considered the radiative path between the two and placing a secured document with suitable radiation-interfering and/or radiation-absorbing materials embedded within can be determined by the systems shown in FIGS. 1A-1C. Further, in some examples, the RFID tag 20 can be placed directly in contact with a transceiver 10, and a document to be authenticated can be placed in contact with the RFID tag 20, on the side opposite the one in contact with the transceiver 10. Thus, effects of the radiation-interfering material are observable even where the document is not placed between the RFID tag 20 and the transceiver 10 and instead is positioned near to the RFID tag 20 so as to interfere with the radio frequency field surrounding the RFID tag 20 and its associated antenna portion 24. In some embodiments, effects of the radiation-interfering material are observable even where the document is not placed between the RFID tag 20 and the transceiver 10 and instead is positioned near to the RFID tag 20 so as to intentionally interfere with the radio frequency field surrounding the RFID tag 20 and its associated antenna portion 24.

Accordingly, some embodiments of the present disclosure generally apply to systems for verifying an authenticity of a secured card by placing the secured document in the presence of a radiation field, and evaluating any effects (dynamic or absolute) on the radiation field attributable to the secured document. For example, the presence or absence of radiation influencing materials within a secured document can be determined by observing the effect of placing a secured document in a radiation field and observing whether the radiation field is modified in a manner consistent with the presence of radiation influencing materials within the secured document. As will be described next in connection with FIGS. 2-4, because such radiation-influencing materials can be embedded within an inner core of a laminated secured document, the presence of such materials can be an effective anti-counterfeiting measure that is substantially covert since the presence of the materials is not apparent upon physical inspection of the document.

FIG. 2A is an exploded view of multiple layers of a three-layer laminated secured card 100. In the illustrated embodiment, the secured card 100 includes a first outer layer 110, an inner core 120, and a second outer layer 112. The secured card 100 is formed by a laminating process to securely couple the three layers together in a laminated stack with the outer layers 110, 112 forming the outside of the resulting secured card 100. In some examples, the secured card 100 is sized to have dimensions similar to a driver's license, credit card, identification badge or card, passport, etc. As discussed above, the inner core 120 can include a conductive radiation-interfering material to provide for authenticating the secured card 100 by evaluating the influence of the affect of the secured card 100 on a radiation field.

FIG. 2B is a top view of the secured card 100 illustrating that the exterior layers 110, 112 can be larger than the inner core 120 so as to envelope (“encapsulate”) the inner core 120. The inner core 120 can be centered within the rectangular shape of the secured card 100, and can be smaller than the secured card 100 in both length and width. For example, the inner core 120 can be separated from the outer edges of the secured card 100 by a distance d1 along a first side, and by a distance d2 along a second side. Thus, the dimensions of the inner core 120 can be less than dimensions of the outer layers 110, 112 by twice the distance d1, and by twice the distance d2, along its length and width, respectively. For example, the distances d1 and d2 can each be approximately 0.125 inches.

By arranging the inner core 120 to be smaller than the outer layers 110, 112, the outer layers 110, 112 form the outer edge of the resulting secured card 100 and combine to completely surround the inner core 120. This approach desirably completely masks the presence of the inner core 120 upon physical examination of the laminated secured card 100. This approach also desirably allows for the two outer layers 110, 112 to be directly connected, coupled or adhered to one another in the overlapped region along the edges to form a stronger laminated bond or seal, particularly instances where the outer layers 110, 112 are each formed of a polymeric material and the inner core 120 is formed of a different material. For example, where the outer layers 110, 112, are formed from a polymeric material such as PVC, PET, ABS, polycarbonate, etc., and the inner core 120 includes a conductive material, the laminated bonds between the outer layers 110, 112 along the outer edges of the secured card 100 are generally stronger and more resilient than bonds between the inner core 120 and the respective outer layers 110, 112, so the seal along the outer edge enhances the structural integrity of the secured card 100.

In some embodiments, the multi-layer card can include additional intermediate layers situated between the inner core 120 and one or both of the outer layers 110, 112. The full stack of outer layers 110, 112, inner core 120, and intermediate layers, if any, can be securely coupled to one another by an adhesive and/or laminating process. In some embodiments, the inner core 120 can be securely coupled to the outer layers 110, 112 via one or more intermediate layers such that the inner core 120 does not directly contact the outer layers 110, 112, for example.

FIG. 3A is a side cross-section view of an inner core 120a of the secured card 100 when the inner core 120a is a substantially uniform layer (“sheet”) of radiation absorbing or deflecting conductive material 122. The conductive material 122 is a material for absorbing, shielding, deflecting, and/or redirecting electromagnetic radiation, such as radiation employed at typical power levels and frequencies for an RFID system. The conductive material 122, can include particles of suitable conductive material such as aluminum, copper, silver, nickel, iron, alloys thereof, or the like in powder form. Non-metallic materials such as carbon, carbon-loaded matrix material, graphite, carbon nanotubes, combinations of the foregoing, combinations of the foregoing with metal, and the like can also be included in the conductive material 122.

FIG. 3B is a side cross-section view of another inner core 120b of the secured card 100 when the inner core 120b is a polymeric substrate 124 including distributed embedded conductive particles 126 to provide radiation absorption and/or deflection. The distributed embedded particles 126 can be substantially uniformly distributed throughout the polymeric substrate 124 or can be preferentially distributed along one surface as shown in FIG. 3B. The embedded particles 126 can be formed of the same or similar conductive materials as the conductive material 122 described above.

FIG. 3C is a side cross-section view of another inner core 120c of the secured card 100 when the inner core 120c includes a conductive sheet 128 adhered to a polymeric substrate 130 to provide radiation absorption and/or deflection. FIG. 3D is a side cross-section view of another inner core 120d of the secured card 100 when the inner core 120d includes two sheets of conductive material 128, 132 sandwiched around a polymeric substrate 130 to provide radiation absorption and/or deflection. The conductive materials 128, 132 can be the same or similar as the conductive material 122 described in connection with FIG. 3A.

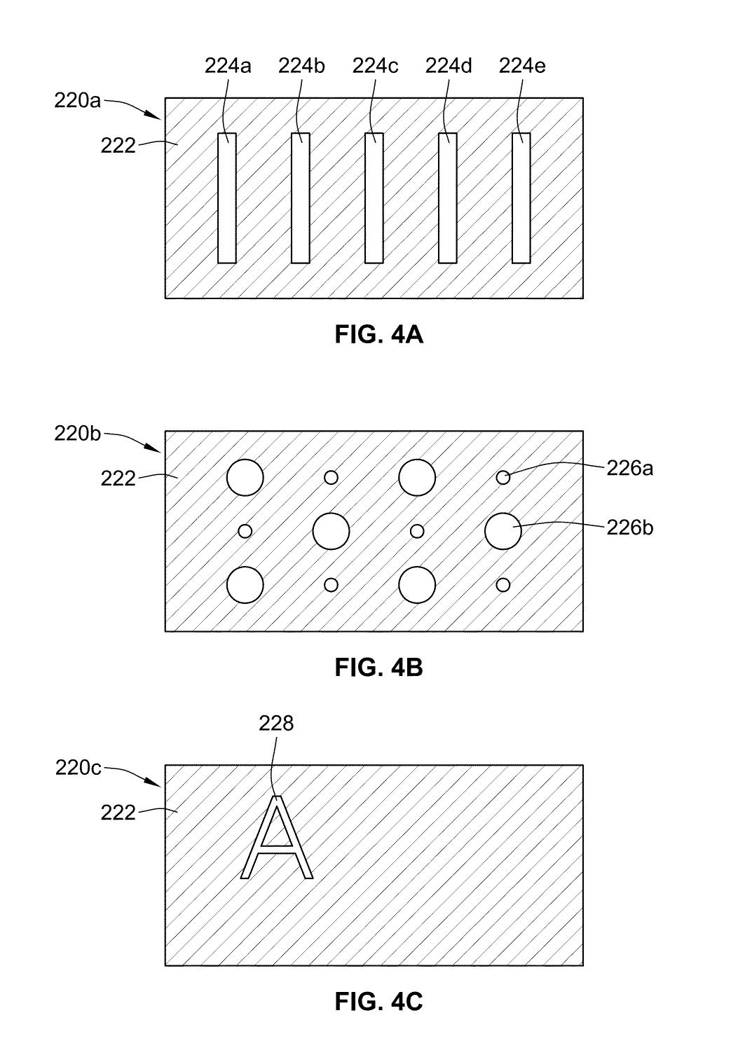

Furthermore, aspects of the present disclosure provide for secured documents configured to modify incident radiation in a characteristic manner according to the amount and/or distribution of radiation-influencing material within the inner core of the document. For example, radiation can be selectively transmitted such that the transmitted portion is distinguishable from the incident radiation. For example, the inner core can filter incident radiation by frequency such that the power spectral density of transmitted radiation is distinguishable from the incoming radiation. FIGS. 4A-4C provide examples of various exemplary distributions of conductive materials in an inner core arranged to modify incident radiation. In some embodiments, the distributions in FIGS. 4A-4C can be rearranged and/or combined to provide a desired distribution.

FIG. 4A is a top view of an inner core 220a of the secured card 100 when the inner core 220a includes a radiation-interfering material 222 with slits 224a-e passing through to create a grating suitable for intentionally interfering with radiation. In some examples, the radiation-interfering material 222 can include a conductive material similar to those discussed in connection with FIGS. 3A-3D for interfering/shielding/redirecting/absorbing radiation employed in RFID systems. According to some embodiments, the slits 224a-e can be a series of parallel elongated slits in the sheet of otherwise substantially continuous conductive material 222. The exemplary arrangement in FIG. 4A includes five slits, but other radiation-influencing gratings can be constructed with more than five slits, or fewer than five slits, such as three, four, six, etc. The dimensions of the slits 224a-e and/or the spacing between the adjacent slits 224a-e can be determined according to the wavelengths of the incident radiation to be influenced, for example.

FIG. 4B is a top view of another inner core 220b of the secured card 100 when the inner core 220b includes the radiation-interfering material 222 with one or more apertures 226a, 226b passing through to create a grating suitable for intentionally interfering with incoming radiation. The dimensions, spacing, etc., of the apertures 226a, 226b can be selected according to the wavelengths of the incident radiation to be influenced, for example.

FIG. 4C is a top view of another inner core 220c of the secured card 100 when the interior layer includes a radiation shielding conductive material 222 with one or more perforations passing through and arranged in a pattern of alphanumeric characters 228. In FIG. 4C, the pattern of perforations resembles a capital letter “A,” however other alphanumeric features, symbols, logos, etc., can be illustrated by a pattern of perforations in the conductive material 222.

With reference to FIGS. 4A-4C, the various features in the conductive material 222 (e.g., the slits 224a-e, the holes 226a, 226b, the character 228) can be constructed by cutting out or stamping out regions of a substantially continuous sheet of the conductive material 222. Alternatively, the layer of conductive material 222 can be developed in the regions surrounding the slits 224a-e while selectively omitting material so as to produce a layer with the slits 224a-e. For example, the inner core 220a can be developed by a three-dimensional printer that selectively applies materials in successive layers to develop a three-dimensional laminated structure.

In other examples, the radiation-interfering material 222 of the inner cores 220a-c can be an optically opaque material for absorbing, blocking, redirecting, or otherwise influencing radiation at visible wavelengths. In such examples, a secured document with an inner layer (“inner core”) including a pattern of apertures through the inner layer can appear to have a water-mark based on the pattern of apertures. For example, where a pattern of apertures is arranged according to the shape of the capital letter “A,” as in FIG. 4C, the assembled secured document will have a region of increased transparency that corresponds to the shape of the capital letter “A.” Thus, as a result of a perforation pattern in the inner layer, the secured document appears to have a water-mark with an appearance similar to the perforation pattern due to the differential transparency of the document in the regions where the inner layer is present (i.e., regions other than the perforations) and regions where the inner layer is not present (i.e., in the perforations themselves).

In some embodiments, a secured document or laminated secured card can be verified as authentic by observing a verification image (“security image”) as a watermark in the document or card. Such a verification image or watermark can be an image that corresponds to a pattern of perforations through an inner layer of the multi-layer document or card. The verification image is apparent when the document is held up to a backlight to observe the verification image according to the differential transparency provided by the pattern of perforations. Additionally or alternatively, the verification image can be apparent when placing a light source on one side of the secured document or card and observing the light that is transmitted through the card on a back screen or reader. Some embodiments can optionally include a two-dimensional image reader, such as a CCD array configured to detect a pattern of light transmission and/or reflection through a secured document or card when subjected to one or more light sources.

Additionally or alternatively, some secured documents or cards can combine the absorption and deflection of radio frequency signals, such as those employed in an RFID system, with selective transmission and/or reflection of optical light through the document to provide multiple methods for verifying a document as authentic. For example, a secured card including the inner core 220c of FIG. 4C can be verified by observing the absorption and/or deflection of radio frequency energy and by observing a watermark-like pattern in the card shaped according to the perforation pattern 228.

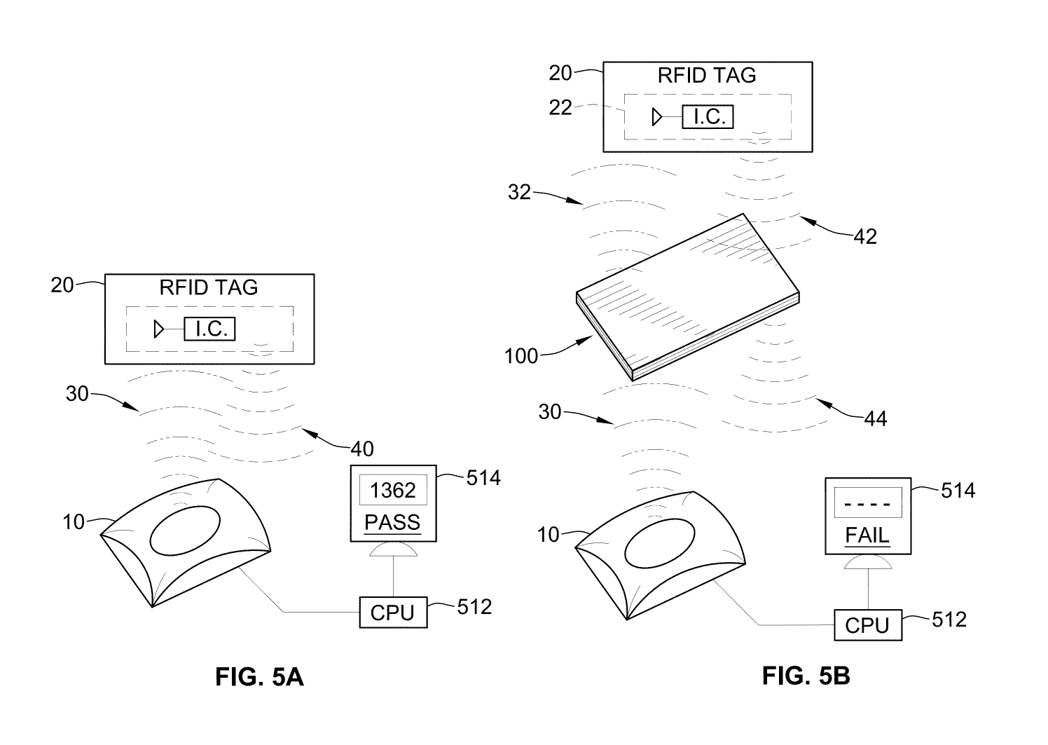

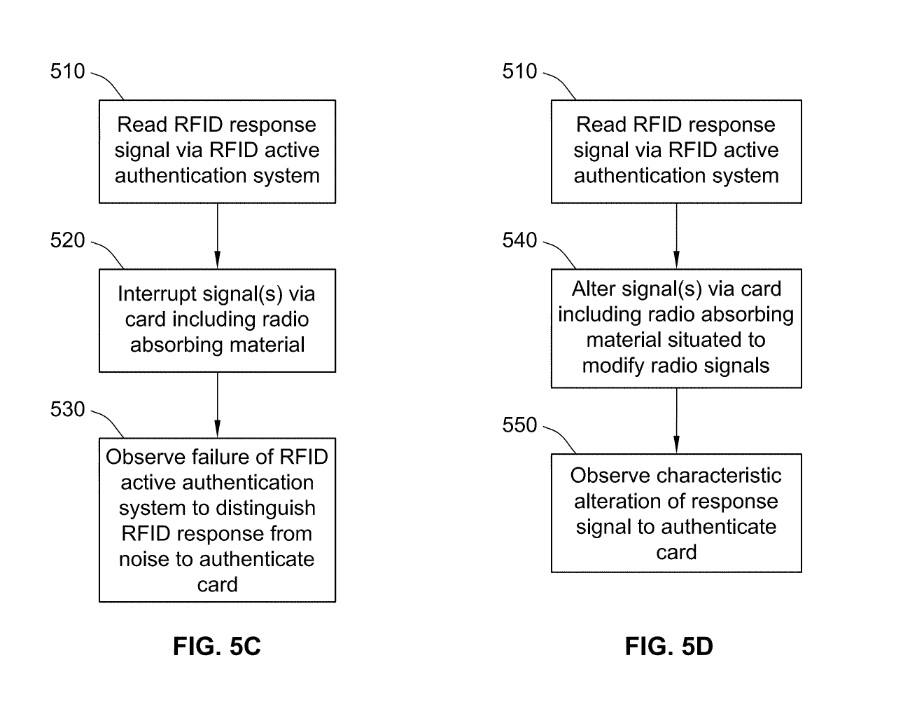

FIG. 5A is a block diagram of the verification system of FIGS. 1A to 1C attached to a processor 512 suitable for detecting and interpreting a signal 40 from the RFID tag 20 in the absence of the secured card. The processor 512 analyzes the received radiation 40 according to signal processing methods to decode the embedded information in the received radiation. The embedded information can then be displayed on an associated display 514. In FIG. 5A, the display 514 shows an exemplary string of numbers: “1362” indicating the information embedded in the received radiation 40.

FIG. 5B is a block diagram of the verification system shown in FIG. 5A with the secured card 100 situated to intentionally interfere with the radiation 30, 42 and thereby causing the processor 512 to fail to recognize, distinguish, and/or decode the signal from the RFID tag 20. To indicate the processing failure, the display 514 shows a series of non-numbers: “- - - -” to indicate that a signal was not received or that embedded information was not retrievable from the received signal.

FIG. 5C is a flowchart for verifying an authenticity of a secured card by causing an RFID detection system such as shown in FIG. 5B to fail to recognize signals due to absorption of the signals by the secured card 100. A response signal from an RFID system is read (510), which indicates that the RFID system is able to receive and decode signals in the absence of the secured card. The signals to the receiver are interrupted, scattered, and/or redirected by placing the secured card 100 in the path of the radiation to the receiver (520). The secured card 100 is then verified as authentic if the system fails to recognize the RFID response signal (e.g., fails to distinguish the response signal from background noise) and/or fails to decode embedded data in the response signal (530).

FIG. 5D is a flowchart for verifying an authenticity of a secured card by observing characteristic modifications of an RFID signal due to alterations of the signals by the secured card 100. The RFID response signal is read by the RFID system to indicate no intentional interference with the response signal (510). The response signals are altered by a secured card including radiation-influencing materials (520). A characteristic alteration of the response signal is evaluated to verify an authenticity of the secured card.

Some embodiments described herein apply to an identification document or other secured document containing material that absorbs an RFID or other signal to provide authentication via measurement of absorption or complete absorption, through partial blockage or complete blockage of the response signal and/or backscatter or electrical induction generated signal.

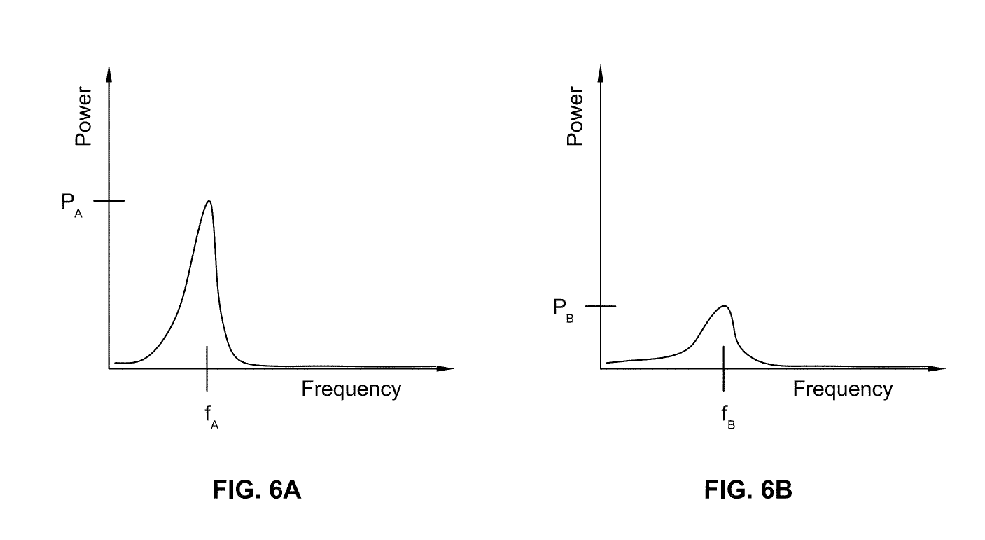

FIG. 6A is an example power spectrum of the received RFID signal in the absence of interference from the secured card 100. The spectrum shown in FIG. 6A corresponds to the circumstance shown in FIG. 5A where the transceiver 10 detects the response signals 40 unimpeded by the secured card 100. As shown in FIG. 6A, the received signal 40 can be characterized by a maximum power P_{A} and a characteristic frequency f_{A}.

FIG. 6B is an example power spectrum of received the received RFID signal after alterations of the signals by the secured card 100. The spectrum shown in FIG. 6A corresponds to the circumstance shown in FIG. 5B where the transceiver 10 detects the transmitted portion 44 of the radiation signals 42 altered via interference with the secured card 100. As shown in FIG. 6A, the received signal 44 can be characterized by a maximum power P_{B} and a characteristic frequency f_{B}.

In some examples, the alteration in the signals via the secured card 100 (and its embedded radiation-altering materials) includes a shift in characteristic frequency of the transmitted portion 44, relative to the unimpeded response signal 40. The frequency shift can be due to partial absorption of radiation and re-emission at slightly different frequencies, and/or due to selective transmission of the response signal 42 via the secured card 100 according to frequency. Thus, in some embodiments, the transmitted portion 44 can be distinguishable from the unimpeded signal 40 by observing a shift in characteristic frequency at the transceiver 10 from, for example, f_{A} to f_{B}. In some examples, the alteration in the signals can also include changes in the received characteristic power, or maximum power, of the received signals. Thus, in some embodiments, the transmitted portion 44 can be distinguishable from the unimpeded signal 40 by observing a change in received power at the detector 10 from, for example, P_{A} to P_{B}.

Aspects of the present disclosure further provide for operation schemes where characteristic alterations in signals detected via the transceiver 10 can be distinguished from false alarm interruptions in the query radiation 30 or response signal 40. For example, RFID signals are known to be partially absorbed, deflected, or otherwise interfered with by, for example, water and/or metallic screens or solid plates. In some examples, the characteristic signal alteration of the response signal 42 via the distribution of radiation-interfering materials in the secured card 100 is distinguishable from other forms of interference, via the characteristic shift in received frequency and/or received power. Furthermore, in some embodiments, the authentication procedure is carried out only while the region between the transceiver 10 and the RFID tag 20 is cleared of any other potential sources of radio frequency interference and/or alteration.

In some embodiments, the alteration, blocking and/or redirection of incident RFID radiation can be characteristically different for distinguishable documents. For example, currency notes including embedded RFID interfering materials can be configured to provide different characteristic interference and/or alterations to incident RFID signals for currency notes with different values. For example, a five dollar bill can be configured to only block RFID signals incident on the center portion of the bill, or portion of the bill including the bust of President Lincoln. In another example, a ten dollar bill can be configured to include an appropriate grating of RFID interfering material to re-radiate incident RFID signals at an increased frequency (e.g., allowing the transceiver 10 to detect a frequency upshift). In another example, a twenty dollar bill can be configured to include an appropriate pattern of RFID interfering material to selectively filter frequencies above a characteristic frequency while transmitting frequencies below the characteristic frequency (e.g., allowing the transceiver 10 to detect a frequency and/or power decrease). The non-limiting examples identified above for characterizing particular denominations of currency notes according to different alterations of incident RFID signals can be applied to other secured documents to distinguish between different types of documents of a related class (e.g., currency) by an automated process (such as in currency processing) and/or during a manual process (such as in counterfeit detection).

In some embodiments, a pattern of voids or apertures (or other pattern of variable opacity) is created in an inner layer of a secured document or card by utilizing perforation, maceration or embossing to facilitate the passing of light or a stream of air through a document for human authentication via observation of the card in the presence of a path of air, ambient light (e.g., environmental light from the Sun), or a focused light source, such as a flashlight, etc. This method can also be used as an authenticator by measuring the light, energy, or path of air that passes through the document. For example, the perforations or embossment area can provide an aperture to focus the image, shape, airflow, or intensity of the light, energy or airflow to facilitate visual or machine detection of airflow authentication and/or measurement of the color, hue or intensity of the light. In some examples, the airflow signature can be an acoustic signature. For example, the pattern of perforations can define an acoustic channel through the card that provides an acoustic signature in response to a stream of air incident on one side of the card. For example, a standardized stream of air can be applied to one side of the card in a controlled, standardized manner, and an acoustic detector, such as a microphone and associated acoustic signal processing system or a human ear, perceives characteristic frequency profile or other signature in the sound waves that result.

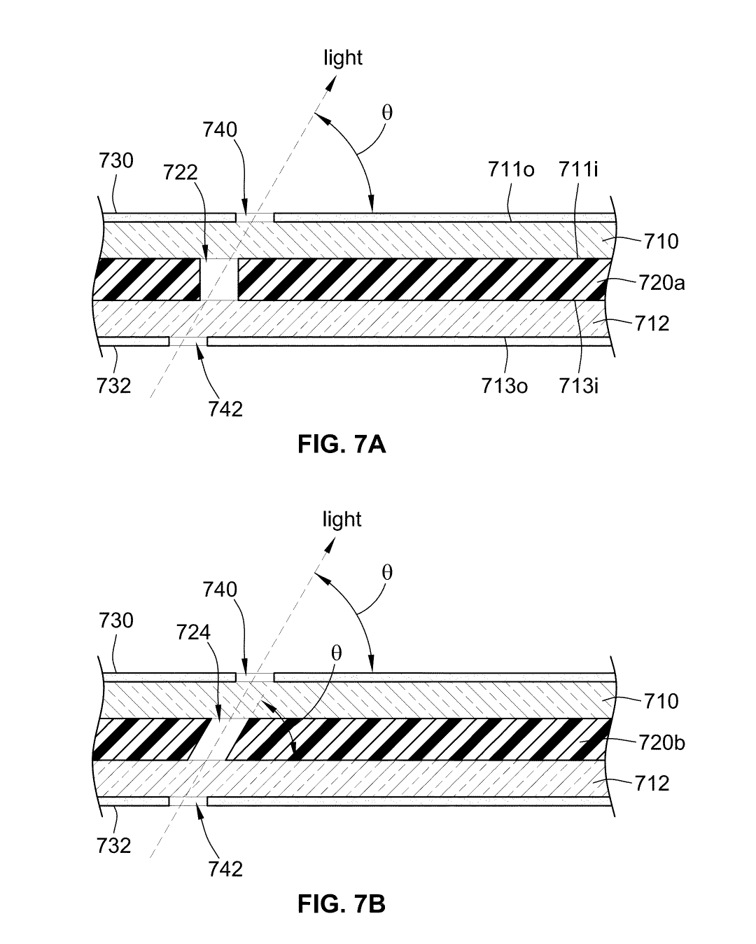

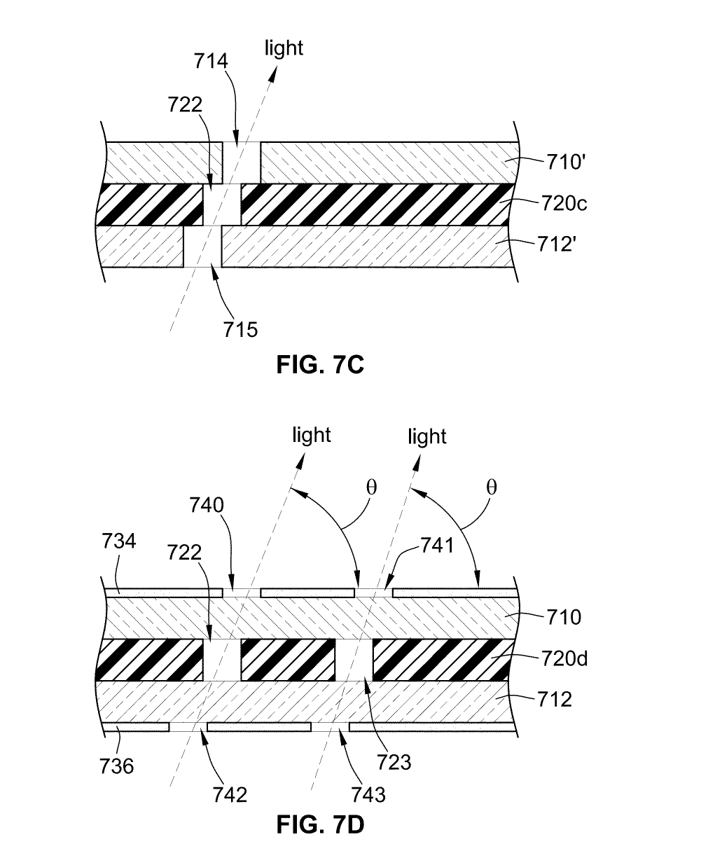

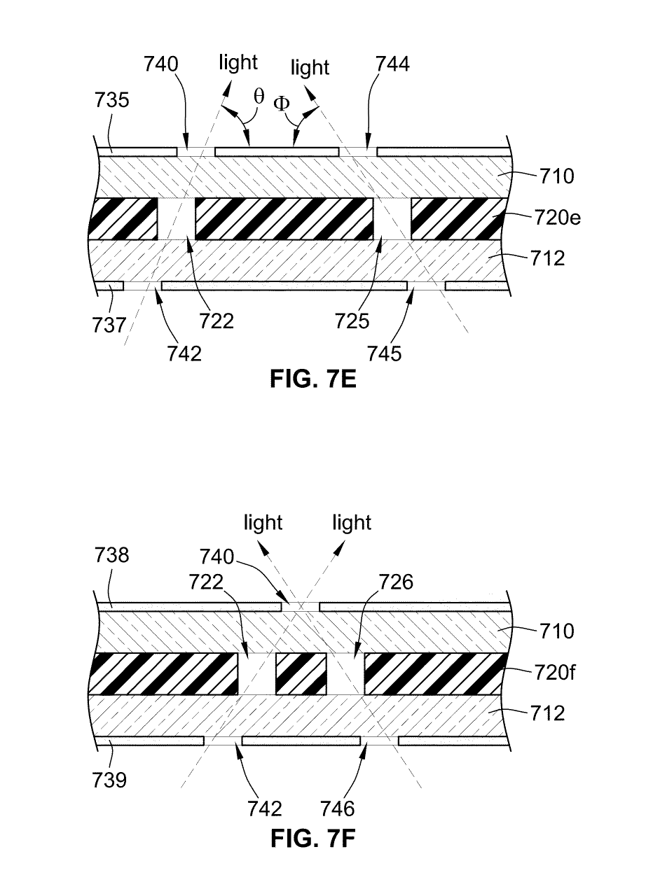

In some embodiments, the pattern of apertures (“perforations”) in the document or card can allow for passage of a beam of light through the card at an angle other than perpendicular to the surface of the document or card. Such an angled light passage can provide a security feature by allowing a watermark-like feature to be evident in the secured document or card due to the transmission of light through the angled light passages. For example, a watermark-like feature can become evident once the secured document or card is tilted or inclined such that the angled light passage is aligned with the observer's eye. Several arrangements of multi-layer documents or cards including such angled light passages are disclosed in connection with FIGS. 7A-7G.

FIG. 7A is a side cross-sectional view of a three-layer secured card (e.g., the secured card 100) including a perforated inner core 720 and transparent regions 740, 742 of the outer layers 710, 712 providing an angled light passage security feature. The view shown in FIG. 7A is a close-in view of a portion of a cross-section of a three-layer secured card. The top layer 710 is formed of a substantially transparent polymeric material, such as PVC, PET, ABS, polycarbonate, etc., and has an inner surface 711i and an opposing outer surface 711o. The bottom layer 712 is similar to the top layer 710 and includes an inner surface 713i and outer surface 713o. The top layer 710 and bottom layer 712 are referred to herein collectively as the outer layers of the secured document or card. The perforated inner core 720a is sandwiched between the outer layers 710, 712 to form a laminated structure. The perforated inner core 720a can be securely connected to the inner surfaces 711i, 713i of the outer layers 710, 712 by an adhesive or by a laminating process.

The outer surface 7110 of the top layer 710 is substantially covered by ink 730 (or another opaque coating). Similarly, the outer surface 713o of the bottom layer 712 is substantially covered by ink 732 (or another opaque coating). The ink 730, 732 can be a base layer of color content suitable for being overlaid with additional colors or tints to, such as a white layer of ink. The substantially continuous layer of ink 730 on the top layer 710 is interrupted by a non-printed region 740. Similarly, the substantially continuous layer of ink 732 on the bottom layer 712 is interrupted by a non-printed region 742. The non-printed regions are alternatively referred to herein as transparent regions, because the non-printed regions 740, 742 of the outer surfaces 711o, 713o, than the respective surrounding regions covered with the ink 730, 732. While the transparent regions 740, 742 can be regions of the outer surfaces 711o, 713o lacking a coating, the transparent regions 740, 742 can also be coated with a substantially transparent coating, rather than the opaque ink 730, 732. Because the ink 730, 732 applied to the outer surfaces 711o, 713o of the card is substantially opaque the non-printed regions 740, 742 define entry and exit points, respectively, for light to pass through the multi-layer document or card. The non-printed regions 740, 742 can be offset with respect to one another such that the resulting light passage is angled with respect to the surface of the card (i.e., the angle θ). In some embodiments, the non-printed region 740 is located so as to be laterally offset from a position defined by projecting the location of the non-printed region 742 through the card, in a direction perpendicular to the surface of the card.

The perforated inner core 720a is a substantially continuous inner layer that can be formed of materials that are the same or similar as the outer layers 710, 712. In some examples, the opacity of the inner layer 720a can be greater than the outer layers 710, 712. The inner layer 720a includes an aperture 722 that passes through the inner layer 720a and thereby defines an inner void or cavity in the card between the inner surfaces 711i, 713i of the outer layers 710, 712. Due to the absence of material in the aperture 722, the transparency of the inner layer 720a is increased at the position of the aperture 722, relative to the regions of the inner layer 720a adjacent to the aperture 722. For example, the index of refraction of the inner layer 720a can be greater than the index of refraction of the air (or other substantially transparent material) filling the aperture 722. The aperture 722 is positioned between the two non-printed regions 740, 742 to define the angled light passage through the document or card. The combination of the placement of the non-printed regions 740, 742 and the aperture 722 define an angled light passage through the card at the angle θ with respect to the surface of the card.

In some embodiments, the size/dimensions of the angled light passage through the card is determined, at least in part, by the size and/or shape of the non-printed regions 740, 742. Generally, the dimensions and/or size of the non-printed regions 740, 742 are determined according to the achievable resolution of the printing technology employed to apply the ink 730, 732. In some examples, the non-printed regions 740, 742 can be as small as a micro-printing feature (e.g., a symbol, character, or shape, such as a circle, etc., sized at a 2 point typographic font size). In some embodiments, the dimensions of the angled passage through the card is also influenced by the size, shape, and/or position of the aperture 722 through the inner layer 720a. For example, where the inner layer 720a is formed of a substantially opaque material, the angled light passage predominantly includes light paths passing wholly through the aperture 722. The dimensions of the aperture 722 can be determined, at least in part, by the cutting, boring, or other material-removing technologies employed to cut out the aperture 722. For example, where a laser is employed to cut the aperture 722 from a solid sheet of the inner layer 720a, the size of the resulting aperture 722 is defined by the size of the cutting laser beam.

Thus, the combination of the placement of the transparent regions 740, 742 and aperture 722 define an angled light path through the multi-layer card at the angle θ with respect to the surface of the document or card. An observer is able to perceive light passing through the document or card when it is tilted and/or oriented such that a ray of light passes through light passage to the observer's eye (or other light sensitive detector). In some embodiments, by situating one or more such angled light paths through a document or card, the observer perceives a watermark-like feature in the document corresponding to the pattern of the one or more angled light paths, but only when the document is tilted to align the light paths with the observer's eye.

In some embodiments, the document or card shown in FIG. 7A is assembled by first removing the aperture from the inner core 720a and then securely coupling the inner core 720a between the outer layers 710, 712, via an adhesive or by laminating the layers together. In some examples, each of the layers 720a, 710, 712 are composed of the same or similar polymeric material such that the resulting laminated document or card resists peeling associated with multiple material laminated structures.

FIG. 7B is a side cross-sectional view of another three-layer secured card including a perforated inner core 720b with an angled aperture 724 and transparent regions 740, 742 of the outer layers 710, 712 providing an angled light passage security feature. The inner core 720b can be the same or similar to the inner layer/core 720a described above in connection with FIG. 7A, except for the inner core 720b includes the angled aperture 724 rather than the aperture 722. The inner core 720b can be formed of a polymeric material, such as PVC, PET, ABS, polycarbonate, etc. and can optionally be formed of the same material as the outer layers 740, 742. The angled aperture 724 is a hole passing through the inner core 720b at the angle of the angled light passage (i.e., the angle θ). In some embodiments, the size/shape of the angled aperture 724 can be determined by projecting a column (or other solid shape with a cross-section defined by the non-printed regions 740, 742) between the transparent regions 740, 742. The inner walls of the angled aperture 724 through the inner core 720b can be defined by the projected column (or other shape).

The angled aperture 724 can be created by cutting the aperture from a solid sheet prior to assembling the multi-layer document or card. For example, a laser cutting beam or boring implement can be oriented at the angle θ with respect to the surface of the inner core 720b to puncture through the inner core 720b at the angle θ. Once perforated, the inner core 720b can then be securely adhered between the outer layers 710, 712 or laminated between the outer layers 710, 712.

FIG. 7C is a side cross-sectional view of another three-layer secured card including a perforated inner core 720c and apertures 714, 715 in the outer layers 710′, 712′ providing an angled light passage security feature. The three-layer secured card in FIG. 7C includes the top layer 710′, the bottom layer 712′ and the inner core 720c sandwiched between the outer layers 710′, 712′. An angled light passage through the multi-layer document or card is defined by the positions of the aperture 714 through the top layer 710′, the aperture 715 through the bottom layer 712′, and the aperture 722 through the inner core 720c. In some examples, the apertures 714, 715, 722 are each positioned to at least partially overlap one another such that a continuous channel through the multi-layer document or card is defined by the apertures 714, 715, 722. In some examples, the continuous channel through the document can be configured to guide and/or redirect a stream of air through the document or card. For example, a stream of air can be applied on one side of the card (e.g., the outer surface 7110 of the top layer 710) and a portion of the incident air can be passed through the document or card via the apertures 714, 722, 715 to exit from the opposing side of the card (e.g., the outer surface 713o of the bottom layer 712). Furthermore, each of the apertures 714, 722, 715 in the respective layers of the document or card can be offset with respect to the others such that the light and/or air passes through the document or card at an angle other than perpendicular to the surface of the card. Any of the apertures 714, 722, 715 can optionally be an angled aperture that is cut out of the respective layers at the angle of light/air passage through the card (e.g., similar to the angled aperture 724 in the inner core 720b described in connection with FIG. 7B).

FIG. 7D is a side cross-sectional view of another three-layer secured card including perforated inner core 720d with multiple apertures 722, 723 and transparent regions 740, 741, 742, 743 of the outer layers 710, 712 providing multiple angled light passage security feature. The top layer 710 is substantially covered by ink 734 (or other opaque coating) with a second transparent region 741 in addition to the transparent regions 740. The bottom layer 712 is substantially covered by ink 736 (or other opaque coating) with a second transparent region 743 in addition to the transparent regions 742. In some examples, the transparent region can be a region not including the applied ink 736, but can also be a region covered by a substantially transparent coating, rather than the opaque coating. The inner core 720d includes a second aperture 723 in addition to the aperture 722. The second aperture 723 is situated between the transparent regions 741, 743 to provide a pathway through the document or card of relatively high transparency (i.e., the light passage oriented at the angle θ with respect to the surface of the document or card).

The document or card shown in FIG. 7D thus includes two commonly-aligned light passages. Accordingly, while the document or card is rigid, the two light passages are approximately parallel in orientation and light through the passages is simultaneously visible to an observer while the document is tilted to align the light passages with an observer's eye. In some embodiments, a character, symbol, or another pattern can be formed from two or more such light passages through a document or card to create a watermark-like feature that becomes visible to an observer while the document is tilted to align the angled light passages with the observer's eye (or another light sensitive detector).

In some embodiments, the common orientation of the light passages defined by the apertures 722, 723 is achieved by positioning each of the respective transparent regions 741, 743 in the second light passage at a location laterally offset from their corresponding transparent regions 740, 742 in the first light passage by the same distance and direction. Similarly, the position of the second aperture 723 can be laterally offset from the first aperture 722 by the same distance and direction along the surface of the inner core 722d.

FIG. 7E is a side cross-sectional view of another three-layer secured card including a perforated inner core 720e with multiple apertures 722, 725 and transparent regions 740, 742, 744, 745 of the outer layers 710, 712 providing multiple angled light passage security features at distinct angles. The top layer 710 is substantially covered by ink 735 (or other opaque coating) with a second transparent region 744 in addition to the transparent regions 740. The bottom layer 712 is substantially covered by ink 737 (or other opaque coating) with a second transparent region 745 in addition to the transparent regions 742. In some examples, the transparent region can be a region not including the applied ink 736, but can also be a region covered by a substantially transparent coating, rather than the opaque coating.

An aperture 725 through the inner layer 720e is situated between the transparent regions 744, 745 to define a second light passage through the document or card. The light passage defined by the transparent regions 744, 745 and aperture 725 is angled with respect to the surface of the document or card (i.e., the angle φ). In some embodiments, the angled light passages through the document or card (e.g., the two passages associated with the apertures 722, 725) can be at distinct angles with respect to the surface of the document or card (e.g., the angles θ and the angle φ). By providing multiple light passages through the document or card at different angles with respect to the surface of the document or card, an observer perceives light passing through the card at multiple tilted orientations. For example, an observer can perceive a first watermark-like feature when the document or card is aligned with the surface of the card approximately at the angle θ with the observer's line of sight, and observe a second watermark-like feature when the document or card is aligned with the surface of the card approximately at the angle φ with the observer's line of sight.

FIG. 7F is a side cross-sectional view of another three-layer secured card including a perforated inner core 720f with multiple apertures 722, 726 and transparent regions 742, 746 of the bottom layer 712 providing an angled light passage security feature with multiple light paths through a single transparent region 740 in the top layer 710. In some embodiments, a character, symbol, or other pattern can be created by multiple such multi-angled light paths such that an observer perceives a watermark-like feature in the same or similar location of the resulting document or card from multiple angles. In some embodiments, an observer can perceive light through the transparent region 740 via the first aperture 722 while the light passage defined by the transparent region 742 and aperture 722 is aligned with the observer's eye. The observer can then perceive light through the same transparent region 740 via the second aperture 726 while the light passage defined by the transparent region 746 and aperture 726 is aligned with the observer's eye.

The angled light passages thought the document including the common transparent region 740 can optionally be situated at complementary angles with respect to the surface of the document or card (e.g., with both oriented at the angle θ with respect to the surface). Where the angles of the light passages are complementary, but in opposite directions, the apertures 722, 726 and the transparent regions 742, 746 can each be positioned with the common transparent region 740 centered between them. For example, the common transparent region 740 can be equidistant from either of the apertures 722, 726, and can be equidistant from either of the transparent regions 742, 746. Accordingly, in some embodiments, a first watermark-like feature is observable while the surface of the document or card is at a first angle with respect to an observer's line of sight, and the same or similar watermark-like feature can be observable again while the surface of the document or card is tilted to another angle.

In another example, angled light paths can be provided through a multi-layered card with pairs of light paths sharing a single aperture in the inner layer, and entering and exiting through respective pairs of transparent regions in the outer layers 710, 712. For example, pairs of light passages through the document or card can be arranged to cross through common aperture in the inner layer to achieve a similar effect as the multiple light paths sharing a common transparent region described in connection with FIG. 7F.

FIG. 7G is a side cross-sectional view of a two-layer secured card including transparent regions 740, 742 of the outer layers 710, 712 positioned to provide an angled light passage security feature. The outer surfaces of the outer layers 710, 712 are substantially covered with the opaque coating 730, 732. In some embodiments, the transparent regions 740, 742 can be regions where the opaque coating is omitted or can be regions covered by a substantially transparent coating. For cards coated with substantially transparent coatings, the card may be authenticated by viewing the card while backlit so as to perceive the pattern of variable opacity (e.g., by holding the card up to the Sun or another light source, for example). The transparent regions 740, 742 thus define entry and/or exit points for light to pass through the two-layer document or card. By offsetting the locations of the transparent regions 740, 742 with respect to one another, the light passage through the document or card is angled with respect to the surface of the document or card (e.g., the angle θ). Thus, in some embodiments, an angled light passage security feature can be provided without including a perforated inner core or inner layer.

Some aspects of the present disclosure provide system and approaches for embedding a watermark image or verification pattern in a multi-layer laminated card formed from a polymeric material such as, for example, PVC, PET, ABS, polycarbonate, etc. Whereas watermark images in paper documents are formed by selectively stamping and/or embossing regions of the paper to create regions of variable transparency defined by differential thickness of the paper (e.g., such as achieved by a dandy roll). Watermarks in paper documents thus rely on the differential transparency of paper at different thicknesses. However, aspects of the present disclosure provide for differential transparency in a laminated multi-layer document by providing an inner perforated layer. For example, the transparency of the laminated multi-layer document can be relatively greater, through the perforated portions, than through surrounding regions. In some embodiments, perforations in the inner layer creates voids or cavities between the outer layers of the multi-layer document or card, and the index of refraction of the air (or other substance) through the cavities is greater than in the surrounding regions of the inner layer such that the pattern of perforations appears as a pattern of relatively greater transparency.

In some examples, perforation patterns are included in a perforated layer formed of a microporous synthetic substrate, such as Teslin®, available from PPG Industries. Such substrates are suitable as the perforated layer because they can be cut with a high degree of precision in a substantially automated manner. So, a perforated microporous substrate is situated between two outer layers of a multi-layer stack to form a card with an embedded watermark-like signature.

Furthermore, aspects of the present disclosure apply to documents or cards with an inner layer having a pattern of non-uniform opacity/transparency (e.g., due to non-uniform thickness of such inner layer). The inner layer of non-uniform opacity/transparency can be created by developing a layer with non-uniform thickness (e.g., via laminated manufacturing techniques) and/or by selectively removing material from an inner core to leave a layer with non-uniform thickness.

In some other examples, a secured document or card with a watermark-like signature can also be created by utilizing a three-dimensional printer or other laminated manufacturing process. A first layer can form the first outer layer of the card, and an inner layer can be selectively deposited in a pattern such that the resulting inner layer includes a pattern of holes/apertures. A final layer can then be laid down over the inner layer to complete the card. Utilizing a three-dimensional printer desirably allows for selectively depositing polymeric materials according to a programmable pattern. Furthermore, the resulting pattern of polymeric material in the inner layer can have a finer, more detailed structure than achieved by selectively removing material from a uniform sheet of polymeric material, such as by cutting, scoring, stamping, etc. In addition, laminated manufacturing techniques, such as using three-dimensional printers, can produce structures with superior structural stability and strength due to stable bonds between layers of the laminated structure. Although some variability is noted depending on the particular assembly materials used by the three-dimensional printer to create the resulting matrix.

Furthermore, with reference to the three-layer card of FIG. 2A, by creating the inner layer (e.g., the core layer 120) from a material similar to the outer layers (e.g., the layers 110, 112), the secure coupling between the layers in the laminated card may be more robust and resilient than typically achieved in a laminated document or card including layers made of distinct materials. Some counterfeit identity card producers have developed techniques to peel apart multi-layered cards and perform modifications to the inner layer before re-laminating the card. Some embodiments thus provide for producing laminated multi-layer cards with greater anti-counterfeiting features than multi-layer cards having inner layers created from different materials, which are subject to de-coupling from the outer layers and peeling apart. Cards formed substantially from a single polymeric material form more resilient bonds between adjacent layers and are therefore less susceptible to counterfeit methods relying on peeling apart multi-layer documents or cards made of different materials.

In some embodiments, the programmable pattern for depositing the polymeric materials by a three-dimensional printing process or similar laminated manufacturing process can be dynamically determined in real time and/or can be arranged to correspond to printed content appearing on the document or card. Thus, some embodiments of the present disclosure provide for dynamically creating substantially unique and/or personalized watermark-like features in multi-layer polymeric cards by an automated laminated object manufacturing process employing three-dimensional printing technologies.

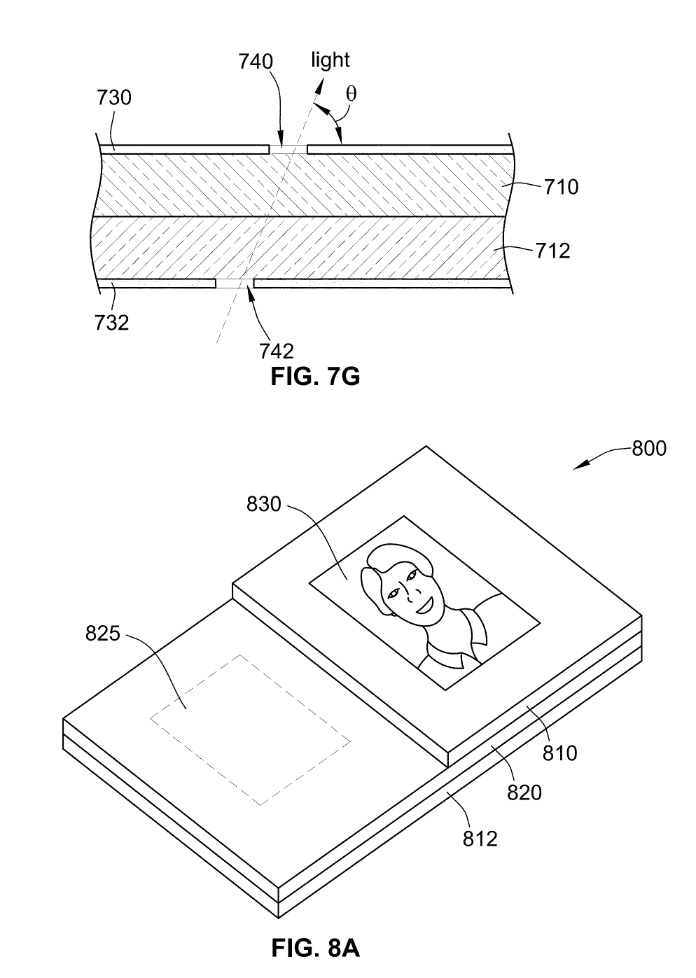

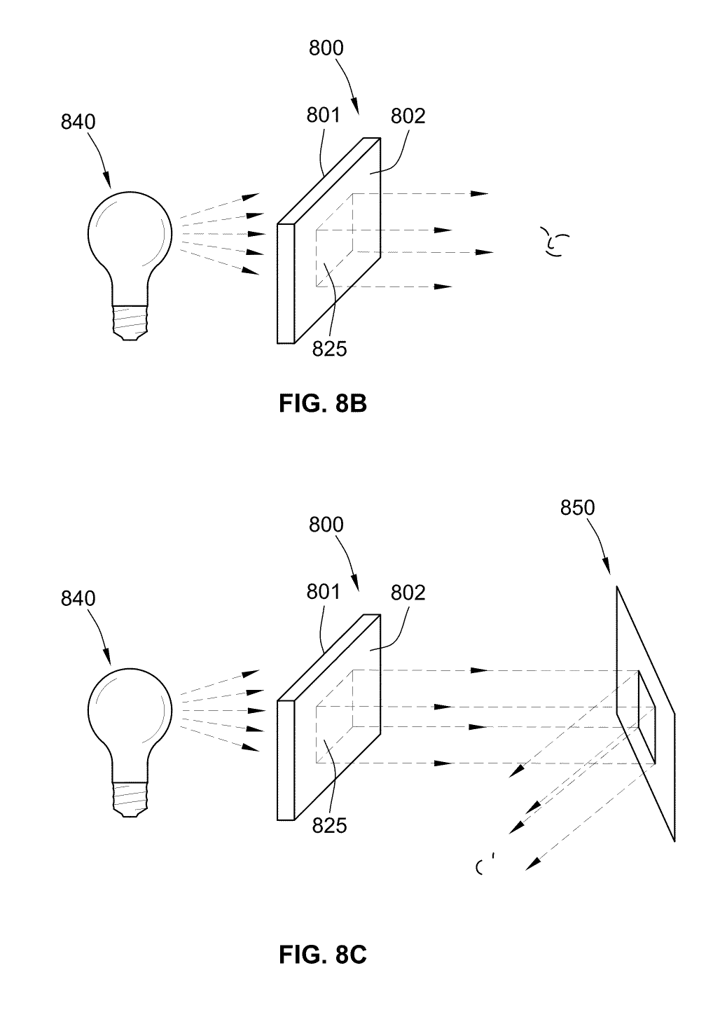

FIG. 8A is an aspect view of a partially cut-away three-layer secured card 800 with a printed face 830 on one side and a region of variable transparency 825 in the inner layer 820 that is configured to provide an embedded water mark corresponding to the printed face 830. The inner layer 820 is sandwiched between a top layer 810 and a bottom layer 812. The pattern of perforations on the inner layer 820 (or patterned inner layer of material) can be a pattern that corresponds to an image of a person's face. For example, an identity card producing system can print the image of the person's face 830 along with pertinent identifying information on the top side of the card 800, and include the embedded layer 820 that is deposited according to a pattern determined by the image of the face in the region 825. The patterned application of the inner layer 820 according to the face in the region 825 provides a watermark-like image of the person's face in the region 825 of the card 800 away from the printed image 830.

The region of variable transparency 825 can be a region of variable thickness such that the transparency of the region 825 at each point corresponds to the thickness of the inner layer 820 at the point. For example, the tint and/or color of the image 830 can be evaluated in a pixelated manner dividing the image 830 into an array of rows and columns. The tint and/or color of each pixel entry can be mapped (“correlated”) to an opacity corresponding to the evaluated content of each pixel according to a theoretical or empirically derived or relationship between image content and opacity. In some examples where the image 830 is a color image, the image 830 can be converted to a grayscale image and pixelated opacity values can be determined from the grayscale image values. The pixelated opacity values can then be mapped to pixelated thickness values of the variable transparency region 825. Furthermore, the resolution of the pixelated thickness values of the region 825 need not correspond to the resolution of the image 830 on a one-to-one basis. For example, the image 830 can have a resolution of 150 by 100 pixels while the thickness of the variable transparency region 825 can be defined by an array of values 75 by 50, where each thickness value maps approximately to four pixels in the image 830.

In some examples, the thickness value at each pixel of the array of values can be achieved by developing the inner layer 820 with one or more apertures (holes, slits, etc.) through the inner layer such that the average material density at each point in the array of thickness values corresponds to the desired thickness. For example, the region 825 can be developed by a three-dimensional printer to have one or more columns spanning the thickness of the inner layer 820 at each point in the array of thickness values, and the width of the columns can be roughly inversely related to the amount of transparency desired at that point of the array of values (or roughly directly related to the amount of opacity desired at that point of the array of values). Developing the region 825 such that at least some portion spans the entire thickness of the layer 820 throughout the region 825 advantageously contributes to the structural integrity of the assembled multi-layer card 800 and makes the card 800 resistant to crushing of squeezing forces.

Each of the above evaluating, mapping, etc. described above can be dynamically performed by a processing system associated with an identity card manufacturing system that receives images and biographical/identifying information (e.g., name, height, weight, eye color, etc.) for each card holder to be printed on an identity card being produced. In addition to controlling the card production system to print the image 830 and/or any identifying information for the individual, the processing system can dynamically determine the pattern of opacity of the region 825 and control a three-dimensional printing system to create the desired watermark-like feature in the inner layer 820 of the card 800.

Additionally or alternatively, the embedded watermark-like feature can be determined at least in part according to information for each person receiving the identity card. For example, the watermark-like feature can be a string of alphanumeric characters providing identifying information associated with the person featured on the identity card, such as, for example, a string indicative of the person's driver's license number, address, name, date of birth, etc. In other embodiments, watermarks can be included to indicate a status (or lack thereof) for a particular person, such as identifying individuals under (or over) ages 16, 18, 21, 25, 65 etc.

Thus, some embodiments of the present disclosure provide for the application of laminated object manufacturing to create an inner void (or absence of material) within a multi-layer document to create regions of differential transparency to light that is perceived as a watermark-like security feature in the multi-layer document which is substantially customizable for each person receiving such cards.

Some embodiments include patterned application of laser light to generate an inner core layer with non-uniform transparency. For example, an inner layer (e.g., polymeric layer or other substrate material) can be exposed to a laser light source to at least partially ablate the inner layer according to a pattern traced by the laser. The laser can be configured to partially vaporize, ablate, or otherwise disintegrate the inner layer in the areas exposed to the laser light such that the inner layer is relatively more transparent in the regions subjected to laser light. For example, the laser may be directed by an electronically controlled system of controllable mirrors, optical elements, and/or point/tilt mechanisms, etc. so as to direct the laser light source to the inner layer according to a desired pattern. In some examples, an array of micro-mirrors individually steered by servo motors according to control signals can selectively direct radiation from a laser light source onto the inner layer to create a desired pattern of non-uniform thickness (and thus a desired pattern of non-uniform opacity). The electronically controlled laser system may therefore be used to create customizable patterns of non-uniform thickness (and thus non-uniform opacity/transparency). For example, a laser light source system may be used to apply light in a pattern based on identity-specific content, such as an individual's signature, an image, etc.

In some cases, a laser light system can include a diffusing optical element to spread the collimated beam of laser light across a region with maximum intensity near the center of the exposed region and minimal laser intensity near the outer fringes. Due to such a radiation pattern, the non-uniform thickness of the inner layer due to the partial ablation of material can have gradually defined transitions in layer thickness (rather than sharply defined transitions). For example, the radiation pattern may ablate the most material (i.e., so as to leave the least material thickness) from the regions of the inner layer exposed to the central portion of a diffused radiation pattern and may ablate gradually less material (i.e., so as to leave the greatest material thickness) from the regions of the inner layer exposed to the outer portion of the diffused radiation pattern. Such gradual transitions in inner layer thickness (and thus inner layer opacity/transparency) may replicate the gradual opacity transitions in watermarks created in paper-based substrates by application of a dandy-roll to moistened paper fibers. The gradual nature of such boundaries on the pattern of non-uniform opacity may therefore provide an additional technique for authenticating secured documents and/or cards disclosed herein.

Generally, the techniques described for laminated object manufacturing (e.g., three-dimensional printing) can be applied to paper or foil substrates as well as polymeric substrates to develop material according to a pattern resulting in holes through the material, rather than cutting holes through uniform sheets of material. For example, a watermark in a paper document can be created by depositing paper fibers (“particles”) in a pattern rather than using a dandy roll to rearrange (“move”) fibers apart in the wet pulp process.

FIG. 8B is a diagram of an observer viewing the variable transparency through the secured card 800 to authenticate the card. FIG. 8C is a diagram of an observer viewing the variable transparency through the card 800 by observing a pattern on a screen 850 to authenticate the card. A light source 840 is situated on one side 801 of the secured card 800 to allow the card 800 to be verified as authentic according to light selectively passed through the card 800 to exit from the opposing side 802. For example, in FIG. 8B, the card 800 can be verified as an authentic card by holding the card 800 up to a light source 840 and comparing the watermark-like image of the face (observable via the variable transparency of the region 825) with the printed image 830 of the face to determine that the card 800 is authentic. Similarly, in FIG. 8B, the card 800 can be held up to the light source 840 to allow light to pass through the card 800 to the screen 850, and the watermark-like image can be perceived on the screen 850 via the variable transparency of the region 825.

FIG. 9A is an exploded view of a two-layer secured document 900 including taggant materials 920, 922 on an inner surface 911i of the assembled document or card such that the taggant materials 920, 922 are embedded within the document 900. The document 900 includes a top layer 912 and a bottom layer 910. The two layers 910, 912 can be securely coupled together when assembled to form the two-layer document. The taggant materials 920, 922 are internally embedded in the assembled document 900 by applying the taggant materials 920, 922 to at least one of the internal faces of the two layers 910, 912 prior to assembling the document 900. For example, the taggant materials 920, 922 can be applied to the inner surface 911i of the bottom layer 910, as shown in FIG. 9A. Additionally or alternatively, taggant materials can be applied to an inner surface (not visible) of the top layer 912. The two layers 910, 912 can be formed of a polymeric material, such as ABS, PVC, PET, polycarbonate, etc., and can also be a plastic-based and/or paper-based substrate. Additionally or alternatively, the two-layer secured document can include radiation interfering and/or absorbing materials encased in a plastic-based and/or paper-based substrate. The resulting radiation interfering and/or absorbing document may then be used similarly to those described above in connection with FIG. 1 above.

Aspects of the present disclosure apply to embedding light spectrum taggants 920, 922 for authentication in an inner core and/or inner surface of a secured document 900 to allow the document to be verified by activating the internally embedded latent taggant features. In some embodiments, the taggant materials 920, 922 can be fluorescent materials (e.g., an ink, coating, etc.) that emit visible, ultraviolet and/or infrared light in response to receiving (“absorbing”) radiated energy, such as light energy. Activating the taggant materials 920, 922 can cause the materials 920, 922 to reveal a glowing pattern in the interior of the document 900 as visible light (FIG. 9B). The taggant materials 920, 922 can be activated by subjecting the document 900 to UV or IR light, or other radiative energy, depending on the chemistry and/or electro-optical properties of the taggant micro-particles and/or nano-particles included in the taggant materials 920, 922. In some examples, a verification image is revealed in UV or IR light and can be observed via a detector sensitive to light energy at those wavelengths.

In some embodiments, the taggant materials 920, 922 can be included in an inner layer enclosed (“encapsulated”) between outer layers, similar to the multi-layer documents or cards discussed in connection with FIG. 2A, for example. Thus, the taggant material 920, 922 can be printed or deposited as a spot, a series of spots, an alphanumeric image, etc. on an inner layer (“inner core”) and/or inner surface of the document 900.

Authentication can also be achieved by marking or saturating the top, bottom or core material with UV or IR or other taggant images that allow for a UV or IR or other detector to verify the images contained inside the document. In some embodiments, the detected images/patterns can be compared with visible information on the document (or other information retrievable from the document or from another source) to provide a multi-step authentication procedure that verifies the consistency of the detected image with predetermined or dynamically determined features. In some embodiments, authentication of the secured document 900 can be carried out by confirming the presence of the hidden (“embedded”) taggant materials 920, 922 or by matching the pattern of the taggant material with a known symbol or pattern. In some embodiments, chemical taggants can be hidden in an inner layer (e.g., a sub-surface of a document), thereby creating a truly covert security feature not perceivable by physical inspection of the externally exposed surfaces of the assembled document 900. Moreover, because the embedded security feature is situated in an inner layer of the document 900, the embedded security feature is not able to be altered, even if its presence were to be discovered.

FIG. 9C is a diagram of a two layer secured document 930 constructed by folding over a single sheet so as to enclose taggant materials 960 printed on an inner surface 952 of the folded sheet. The folded sheet has a top half 940 that is folded over on a bottom half 950. The bottom half has an outer surface 951 and an inner surface 952 that will be enclosed by the top half 940 once the folding procedure is completed and the two halves 940, 950 are secured coupled together to complete assembly of the secured document 930. The taggant materials 960 are applied to the inner surface 952 of the bottom half 950 prior to folding over the top half 940 such that the taggant materials 960 are included on the inner surface 951 of the resulting secured document 930. The taggant materials 960 can be the same or similar to the taggant materials 920, 922 discussed above in connection with FIG. 9A.

The multi-layer document 930 encapsulates (“internally encloses”) the taggant materials 960 once the inner surface 952 of the bottom half is 950 is coupled to the top half 940. Accordingly, some embodiments of the present disclosure provide for producing a secured document including latent security features via taggant materials by printing taggant materials on one side of a unitary sheet of paper and/or plastic based substrate, folding over the sheet, and sealing the edges of the sheet together with the taggant materials on the inside. By situating the taggant materials on the inside surfaces, the taggant materials are not readily evident from the outside of the document until they are activated by a UV or IR light source, or another suitable radiative energy source. The resulting sealed document 930 can be verified as an authentic by virtue of its embedded taggant features 960.

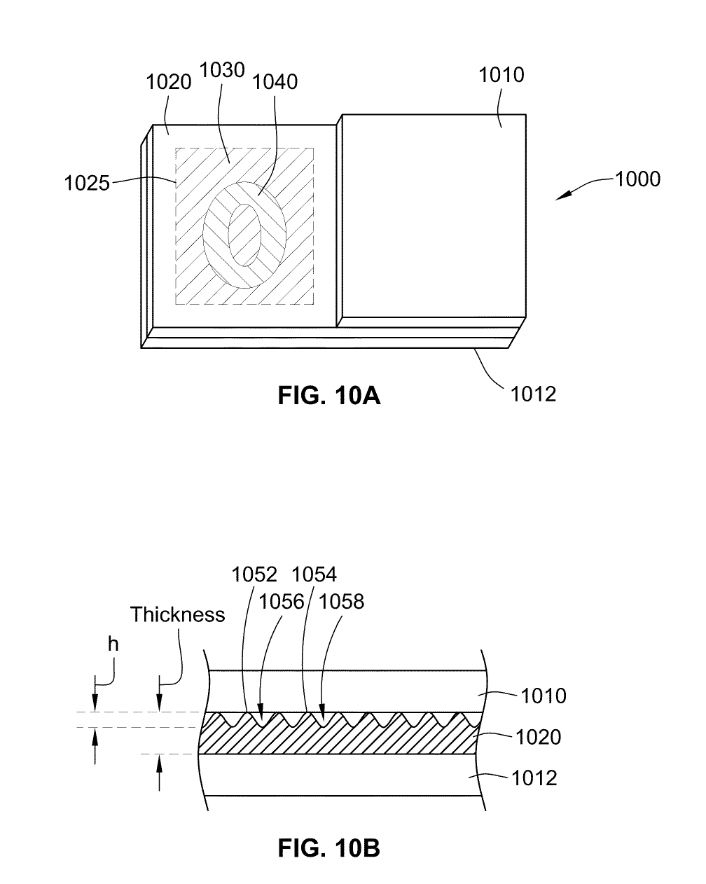

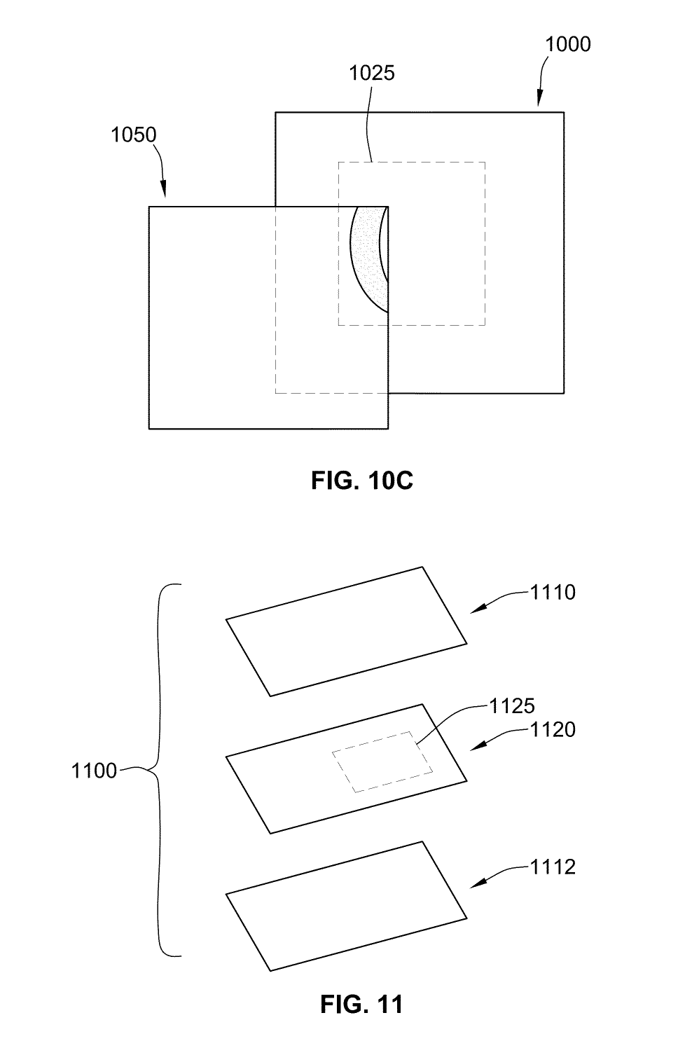

FIG. 10A is an aspect view of a multi-layer secured card 1000 with an inner layer 1020 configured as a lens with striated variable transparency providing a latent image 1040 embedded in a background setting 1030. FIG. 10B is a side cross-sectional view of the three-layer secured card 1000 including the inner layer 1020 with striated variable transparency provided by variable thickness in the inner layer 1020. The secured card 1000 includes a top layer 1010 and bottom layer 1012, each of which can be formed of a substantially transparent polymeric material such as, for example, PVC, PET, ABS, polycarbonate, etc. The inner layer 1020 can also be a polymeric material and can optionally be formed of the same material as the outer layers 1010, 1012. The inner layer 1020 includes a region 1025 of non-uniform transparency. The region 1025 is configured to have an opacity/transparency that varies according to a striated pattern of variable thickness. For example, the region 1025 can have a variable thickness with a flat first surface and an opposing surface characterized by a pattern of ridges (e.g., the ridge 1052) and valleys (e.g., the depression 1056), as shown in FIG. 10B. Because the opacity of the assembled card 1000 is determined, at least in part, according to the combined thickness of the three layers 1010, 1012, 1020 at each point of the card 1000, the region 1025 has a variable opacity/transparency arranged in a pattern of lines. Thus, some embodiments provide for the region 1025 to resemble one or more opacity line-screen patterns.

In the illustrations of FIG. 10A, the individual “lines” in the resulting variable opacity pattern are shown for illustrative purposes, but FIG. 10A is not necessarily drawn to scale. In some embodiments, the spatial frequency of the opacity pattern can be 65 peaks per inch to 300 peaks per inch. The spacing of the adjacent peaks (e.g., the distance from the peak 1052 to the peak 1054) defines a line screen pattern of opacity through the card 1000.

The valleys (“depressions”) 1056, 1058 between the adjacent peaks 1052, 1054 of the inner layer 1020 are regions of relatively increased transparency because the air (or other substantially transparent material) situated in the valleys is more transparent than the material forming the peaks 1052, 1054. In the assembled card 1000, the valleys 1056, 1058 are voids or cavities between the top layer 1010 and the inner layer 1020. In some embodiments, vacuum sealing technologies are employed to substantially evaluate particles of air or other materials in the cavities formed by the depressions 1056, 1058. The cavities have a maximum height dimension (labeled as “h” in FIG. 10B) defined by the difference between the thickness of the inner layer 1020 at the peaks 1052, 1054 and the thickness of the layer at the center of the depressions 1056, 1058. The size (“dimension”) of the heights of the peaks, relative to the depressions (i.e., the dimension “h”) can be selected to provide a desired amount of differential opacity between the peaks and the depressions. In some embodiments, the variation in opacity can be approximately a few percent to 20%. In some embodiments, the total thickness at the peaks 1052, 1054 can be selected to provide opacity of approximately 50% to approximately 100%. To create the opacity line screen patterns in the region 1025, the cross-sectional profile of the inner layer 1020 shown in FIG. 10B is extended to form a pattern of substantially straight, evenly spaced, parallel ridges of relatively greater opacity than the depressions between them.

The region 1025 includes two distinct line-screen patterns, a background image 1030 and a latent image 1040. The background and latent image 1030, 1040 can each be formed by opacity line-screen patterns oriented at 90 degrees with respect to one another, as illustrated by FIG. 10A. That is, the background 1030 can be a region with evenly spaced, parallel ridges running in a first direction, and the latent image 1040 can be a region with evenly spaced, parallel ridges running in a second direction. The second direction (of the latent image 1040) can optionally be perpendicular to the first direction (of the background 1030). The spacing between adjacent peaks can optionally be the same in the background 1030 and the latent image 1040, or the two can have different peak spacing. For example, the background 1030 can have ridges oriented at 45 degrees spaced at 65 peaks per inch and the latent image 1040 can have ridges oriented at 135 degrees spaced at 130 peaks per inch.

In some embodiments, the inner layer 1020 can be formed by heating the inner layer 1020 and applying a die or stamp to deform the inner layer 1020 according to the desired opacity line-screen pattern. The applied die or stamp is shaped with a negative image of the desired shape of the variable opacity line screen pattern formed in the region 1025.

Generally, the arrangement (and even the existence) of the latent image 1030 within the variable opacity region 1025 of the inner layer 1020 is not readily discernible to the unaided human eye. However, the latent image 1030 can become apparent with assistance of a suitable viewing aid as shown in FIG. 10C.

FIG. 10C is a top view of the assembled secured card shown in FIG. 10A where the latent image 1040 is revealed by a viewing aid 1050 situated over the card 1000. The latent image 1040 can be an alphanumeric character, a symbol, a pattern, or another verification image. The viewing aid 1050 is a lens with a line screen pattern created by a pattern of striated variable thickness in the viewing aid. The viewing aid 1050 selectively interferes with the opacity pattern of either the background 1030 or the latent image 1040 to allow the latent image 1040 to be discernible from the background 1030 by the resulting moire interference pattern once the viewing aid is aligned with one or the other of the background 1030 or latent image 1040. Where the viewing aid has a spatial frequency approximately equal to the frequency of the background 1030, aligning the viewing aid 1050 with the background 1030 causes the background 1030 to become more or less visible than the latent image 1040 such that the latent image 1040 become discernible.

FIG. 11 is an exploded view of a three-layer card 1100 with an inner layer 1120 including a metallic and/or magnetic material 1125 sufficient to activate a metal detector. The inner layer 1120 is securely coupled to outer layers 1110, 1112 by an adhesive, by lamination, etc. The metallic and/or magnetic material 1125 can be embedded in the inner layer 1120 as a solid slug of material such as iron, steel, or other metals and/or ferromagnetic materials. In some embodiments, metallic and/or magnetic materials 1125 can be applied to the inner core 1120 (or to another inner surface of the card 1100) by applying a coating of such materials, such as, for example, via powder coating process. In some embodiments, metallic and/or magnetic materials can be applied by embedding such materials in ink or other coatings applied to the card 1100 on an inner and/or outer surface of the card 1100.

Such embedded metallic and/or magnetic materials can be detected by the resulting cards adhering to ferromagnetic surfaces. Additionally or alternatively, such embedded metallic and/or magnetic materials can be detected by a device configured to detect signals indicative of the presence of metallic and/or magnetic materials, such as a metal detector, for example. Signals from such a device can then be used to authenticate the card 1100 by indicating the presence of the metallic and/or magnetic material 1125.

The metallic and/or magnetic material 1125 is desirably applied in sufficient quantity to activate an industrial metal detector such as those employed in pharmaceutical, food, beverage, textile, garment, plastics, chemical, lumber, and packaging industries. Thus, the industrial metal detectors that routinely scan products (such as food or other edible goods) for metal shards from broken processing machinery employed in the manufacturing process can also detect the presence of the card 1100 in the scanned products. The card 1100 is therefore suitable for use as an identity card for workers or other personnel in such an industrial processing facility because the presence of the card 1100 can be automatically determined and thereby prevent the accidental inclusion of an identity card in a delivered product. In some examples, the metallic material 1125 can be arranged so as to avoid interference with an RFID antenna. For example, the metallic material 1125 may be arranged in a horizontal stripe, a vertical stripe, and/or in a circular loop within a plane of the card 1100.

Some embodiments of the present disclosure accordingly provide for creating an identity card for use by personnel in a facility producing edible goods or other products that includes embedded metallic and/or magnetic material 1125 in an amount sufficient to activate an industrial metal detector.

Aspects of the present disclosure are described by way of example herein in connection with documents and laminated cards. However, aspects of the present disclosure for embedding security features within an inner layer of a multi-layer laminated product can be applied to documents, cards, labels, cellular phones, tablets, computers, television screens, and other multi-layer substrates.

In some embodiments, aspects disclosed herein can be used to provide for physical access control to secured areas. For example, any of the secured documents and/or laminated cards with embedded security features disclosed herein (including combinations thereof) may be used to control physical access to particular locations. For example, a scheme may be employed in which passage through a “choke-point” (e.g., a doorway, corridor, or other physical access to a secured perimeter) is dependent on verifying the authenticity of a secured document or card. Such verification may be carried out by security personnel checking for embedded security features (e.g., by holding up to the light to perceive watermark-like features due to an inner layer with a pattern of non-uniform opacity) or by a device configured to check for embedded security features (e.g., an interrogator configured to detect embedded radiation interfering and/or absorbing materials). Other examples of embedded security features disclosed herein may also be used as alternatives or in addition.

Further still, some embodiments provide for substrates with any of the embedded security features disclosed herein (including combinations thereof) to be incorporated into wearable materials, such as clothing. Individuals wearing the clothing may then be authenticated and/or detected on the basis of the embedded security features. For instance, a chokepoint for regulating physical access to particular locations may include one or more radio frequency interrogators. The chokepoint may be configured to allow access to individuals wearing clothing or another wearable substrate that is detected by the interrogator due to interference and/or absorption of the radio frequency signals by the embedded security features.

While particular embodiments and applications of the present invention have been illustrated and described, it is to be understood that the invention is not limited to the precise construction and compositions disclosed herein and that various modifications, changes, and variations can be apparent from the foregoing descriptions without departing from the spirit and scope of the invention as defined in the appended claims.

What is claimed is:

1. A method of authenticating a secured document, comprising:
transmitting radiation from an emitter to a detector;
situating the secured document proximate the emitter, or along a radiative path between the emitter and the detector, such that a conductive material embedded in the secured document interferes with the transmitted radiation; and
detecting a modification of the transmitted radiation at the detector, due to the interference by the secured document, to thereby verify an authenticity of the secured document.

2. The method of authenticating a secured document according to claim 1, wherein the conductive material intentionally interferes with the transmitted radiation by substantially absorbing the transmitted radiation and wherein the detecting the modification of the transmitted radiation includes detecting an absence of the transmitted radiation.

3. The method of authenticating a secured document according to claim 1, wherein the conductive material intentionally interferes with the transmitted radiation by substantially deflecting the transmitted radiation and wherein the detecting the modification of the transmitted radiation includes detecting an absence of the transmitted radiation.

4. The method of authenticating a secured document according to claim 1, wherein the detecting the modification of the transmitted radiation includes failing to distinguish the transmitted radiation from a background noise environment.

5. The method of authenticating a secured document according to claim 1, further comprising observing a characteristic pattern of radiation transmitted through the secured document, the characteristic pattern being defined according to a pattern of perforations in at least some layers of a laminated multi-layer structure of the secured document.

6. The method of authenticating a secured document according to claim 5, wherein the pattern of perforations is included in an inner layer of the multi-layer structure such that the transparency of the secured document is greater in the pattern of perforations than in surrounding regions.

7. The method of authenticating a secured document according to claim 1, further comprising observing a characteristic air stream conveyed through the secured document, the characteristic air stream being defined according to a pattern of perforations in at least some layers of a laminated multi-layer structure of the secured document.

8. The method of authenticating a secured document according to claim 7, further comprising applying a standardized air stream to a region of the secured document including the pattern of perforations and wherein the characteristic air stream is defined by an acoustic signature of the conveyed air.

9. The method of authenticating a secured document according to claim 1, wherein the conductive material interferes with the emitted radiation according to a non-uniform spectral response such that a power spectral density of the radiation received at the detector is modified relative to a power spectral density of the emitted radiation.

10. The method of authenticating a secured document according to claim 1, wherein the conductive material interferes with the transmitted radiation by selectively absorbing or deflecting a portion of the emitted radiation and wherein the detecting the modification of the transmitted radiation includes detecting an absence of the selectively absorbed or deflected radiation.

11. The method of authenticating a secured document according to claim 1, wherein the radiation transmitted from the emitter is suitable for use in a radio frequency identification system.

12. The method of authenticating a secured document according to claim 1, wherein the conductive material interferes with the transmitted radiation by modifying at least one of a frequency distribution or intensity of the transmitted radiation.

13. The method of authenticating a secured document according to claim 1, wherein the conductive material is situated in an inner layer of a polymeric multi-layer stack.

14. The method of authenticating a secured document according to claim 1, wherein the conductive material is at least one layer of a multi-layer stack.

15. The method of authenticating a secured document according to claim 1, further comprising, responsive to verifying the authenticity of the secured document, granting access to a physical location to an individual associated with the secured document.

16. A multi-layer secured card comprising:
an inner layer including a conductive material configured to interfere with incident radiation such that a modification in the incident radiation is observable; and
a first outer layer and a second outer layer situated on opposing sides of the inner layer so as to surround the inner layer.

17. The multi-layer secured card according to claim 16, further comprising one or more intermediate layers situated between the inner layer and at least one of the first or second outer layers, and wherein the inner layer is securely coupled to at least one of the first or second outer layers via the one or more intermediate layers.

18. The multi-layer secured card according to claim 16, wherein at least some layers of the multi-layer secured card include a pattern of perforations such that the transparency of the secured card is greater in the pattern of perforations than in surrounding regions.

19. The multi-layer secured card according to claim 16, wherein the inner layer is arranged with a pattern of perforations through the inner layer, the pattern of perforations being arranged such that a verification pattern corresponding to the pattern of perforations is distinguishable in response to incident light being reflected from, or transmitted through, the secured card.

20. The multi-layer secured card according to claim 16, further comprising a perforated layer situated between the inner layer and at least one of the first or second outer layers including a pattern of perforations through the perforated layer arranged in a verification pattern

21. The multi-layer secured card according to claim 16, wherein the conductive material interferes with the transmitted radiation by substantially absorbing the incident radiation such that the modification in the incident radiation includes an absence of the incident radiation observable by a detector situated such that the secured card is proximate a source of the incident radiation or along a radiative path between the source and the detector.

22. The multi-layer secured card according to claim 16, wherein the conductive material interferes with the transmitted radiation by substantially deflecting the incident radiation such that the modification in the incident radiation includes an absence of the incident radiation observable by a detector situated such that the secured card is proximate a source of the incident radiation or along a radiative path between the source and the detector.

23. The multi-layer secured card according to claim 21, wherein the absence of the incident radiation is observable by the detector in response to the detector failing to distinguish the incident radiation from a background noise environment.

24. The multi-layer secured card according to claim 16, wherein the conductive material interferes with the transmitted radiation by modifying at least one of a frequency distribution or intensity of the transmitted radiation.

25. The multi-layer secured card according to claim 16, wherein the conductive material includes at least one of: a conductive metal material, a non-metallic conductive carbon-based material, or a conductive gel.

26. The multi-layer secured card according to claim 16, further comprising a channel through the secured card situated to receive a standardized air stream conveyed through the secured document, the characteristic air stream being defined according to a pattern of perforations in at least some layers of the multi-layer secured card.

27. The multi-layer secured card according to claim 15, wherein at least one layer in the multi-layer secured card includes a polymeric substrate.

28. The multi-layer secured card according to claim 15, wherein each layer in the multi-layer secured card is formed from a common polymeric substrate such that the multi-layer secured card is a laminated card formed from a substantially uniform material.

29. A system comprising:
an emitting antenna for emitting radio frequency radiation;
a receiving antenna for detecting the emitted radiation from the emitting antenna and producing signals indicative of the detected radiation; and
a controller for receiving the signals from the receiving antenna and dynamically detecting a modification in the received radiation to determine whether the modification in received radiation corresponds to a radiation modification profile associated with an authenticated document.

30. The system according to claim 29, wherein one or more of the emitting antenna, the receiving antenna, or the controller are included in a mobile device.

31. The system according to claim 29, wherein the detected modification includes a change in intensity of the received radiation according to a characteristic rate or magnitude that corresponds to the radiation modification profile.

32. The system according to claim 29, further comprising an integrated circuit associated with the emitting antenna configured to encode retrievable information in the emitted radio frequency radiation suitable for a radio frequency identification system.

33. The system according to claim 29, wherein the controller is further configured to, in response to detecting the modification, cause access to be granted to a physical location to thereby regulate access to the physical location based on occurrence of the detection of the modification.

34. A method of producing a multi-layer secured card, comprising:
generating a first layer with a pattern of non-uniform transparency; and
connecting the first layer to a second layer; and
wherein a distinguishable pattern corresponding to the pattern of non-uniform transparency is revealed in response to light transmission through the secured card.

35. The method according to claim 34, further comprising:
connecting the first layer to a third layer such that the first layer is embedded within the second and third layers.

36. The method according to claim 34, wherein the generating the first layer includes:
perforating through the first layer according to a perforation pattern.

37. The method according to claim 34, wherein the generating the first layer includes:
directing a laser light source toward the first layer so as to etch away material from the first layer according to a particular pattern so as to create a pattern of non-uniform thickness corresponding to the pattern of non-uniform transparency.

38. The method of producing a multi-layer secured card according to claim 34, wherein the generating the first layer includes developing incremental layers via a three-dimensional laminated printing device so as to create a pattern of non-uniform thickness corresponding to the pattern of non-uniform transparency.

39. The method of producing a multi-layer secured card according to claim 36, wherein the perforating includes cutting the pattern through the inner layer via a laser cutting system.

40. The method of producing a multi-layer secured card according to claim 34, wherein the connecting includes laminating the first layer to the second layer.

41. The method of producing a multi-layer secured card according to claim 34, wherein the connecting includes adhering the first layer to the second layer.

42. The method of producing a multi-layer secured card according to claim 34, wherein the first and second layers each include a polymeric material.

43. The method of producing a multi-layer secured card according to claim 34, wherein the pattern of non-uniform transparency is dynamically determined.

44. A multi-layer secured card, comprising:
a first layer with a pattern of non-uniform transparency; and
a second layer connected to the first layer; and
wherein a distinguishable pattern corresponding to the pattern of non-uniform transparency is revealed in response to light transmission through the secured card.

45. The multi-layer secured card according to claim 44, further comprising:
a third layer connected to the first layer such that the first layer is embedded within the second and third layers.

46. The multi-layer secured card according to claim 44, wherein the first layer includes a plurality of perforations through the first layer according to a perforation pattern.

47. The multi-layer secured card according to claim 44, wherein the pattern of non-uniform transparency is generated by directing a laser light source toward the first layer so as to etch away material from the first layer according to a particular pattern so as to create a pattern of non-uniform thickness corresponding to the pattern of non-uniform transparency.

48. The multi-layer secured card according to claim 46, wherein the distinguishable pattern is distinguishable by the transmitted light being preferentially transmitted through the perforations in the pattern of perforations.

49. The multi-layer secured card according to claim 45, wherein the first layer is substantially opaque and the second and third layers are each substantially transparent such that the verification pattern is differentiated from adjacent regions of the card as a pattern having greater transparency than the adjacent regions.

50. The multi-layer secured card according to claim 49, wherein the inner layer is substantially transparent and the first and second layers are each substantially opaque such that the distinguishable pattern is differentiated from adjacent regions of the card as a pattern having higher opacity than the adjacent regions.

51. The multi-layer secured card according to claim 45, wherein an index of refraction of the first layer differs from an index of refraction of at least one of the second or third layers such that the distinguishable pattern is distinguishable by differential reflection angle or transmission angle of the incident light.

52. The multi-layer secured card according to claim 44, wherein the distinguishable pattern appears as a watermark in the secured card.

53. The multi-layer secured card according to claim 46, wherein the perforation pattern includes an outline of an alphanumeric character or symbol.

54. The multi-layer secured card according to claim 44, wherein the inner layer includes a conductive material for interfering with electromagnetic radiation by absorbing or deflecting the radiation.

55. The multi-layer secured card according to claim 45, further comprising an intermediate layer situated between the first layer and at least one of the second or third layers.

56. The multi-layer secured card according to claim 55, wherein the intermediate layer includes a conductive material for interfering with electromagnetic radiation by absorbing or deflecting the radiation.

57. The multi-layer secured card according to claim 45, wherein the second and third layers are laminated to the first layer.

58. The multi-layer secured card according to claim 45, wherein the second and third layers are adhered to the first layer.

59. The multi-layer secured card according to claim 45, wherein at least one of the first layer, the second layer, or the third layer are formed from a polymeric substrate.

60. The multi-layer secured card according to claim 59, wherein the polymeric substrate is at least one of polyvinyl chloride, polyethylene, or polycarbonate.

61. The multi-layer secured card according to claim 45, wherein the second and third layers include transparent regions defining entry and exit points of an angled light passage through the card that passes through at least one perforation in the inner layer.

62. The multi-layer secured card according to claim 61, wherein the distinguishable pattern is indistinguishable while the secured card is perpendicular to an observer's line of sight, but becomes distinguishable once tilted to align angled light passages through the card with the observer's line of sight.

63. A multi-layer secured card comprising:
an inner layer including a metallic or magnetic material in an amount sufficient to activate an industrial metal detector; and
a first and a second outer layer situated on opposing surfaces of the inner layer so as to surround the inner layer, the first, second, and inner layers being securely coupled to one another; and
wherein a verification pattern corresponding to the pattern of perforations is distinguishable in response to incident light being reflected from, or transmitted through, the secured card.

64. The multi-layer secured card according to claim 63, wherein the card is an identity card for personnel in an edible product production facility.

65. The multi-layer secured card according to claim 63, wherein the metallic or magnetic material is a metallic slug enclosed by the first and second layers.

66. The multi-layer secured card according to claim 65, wherein the metallic slug is situated arranged as a horizontal stripe or circular ring, and wherein the multi-layer secured card further comprises an antenna arranged to thereby avoid interference from the metallic slug.

67. A secured card comprising:
a first and a second layer securely coupled to one another along respective inner surfaces of the first and second layers; and
a taggant applied to at least one of the inner surfaces of the first and second layers and arranged in a verification pattern, the taggant being configured to radiate energy to reveal the verification pattern in response to being activated by radiatively received activation energy.

68. The secured card according to claim 67, wherein the radiated energy is at least one of visible, ultraviolet, or infrared light energy.

69. The secured card according to claim 67, wherein the taggant is a fluorescent material configured to emit visible light in response to receiving at least one of infrared or ultraviolet light energy.

70. A multi-layer secured card comprising:
an inner layer including a region of non-uniform opacity defining a line-screen pattern of opacity, the region including a latent image in an integrated background setting, and
wherein the latent image is substantially indistinguishable to the unaided eye, but becomes distinguishable via moire interference patterns generated by an overlaid visual aid having a spatial frequency configured to selectively interfere with at least one of the background or the latent image.

71. The multi-layer secured card according to claim 70, wherein the line-screen pattern of opacity is a region of the inner layer with varying thickness having a plurality of evenly spaced, substantially parallel ridges separated by depressions in the inner layer such that the ridges correspond to parallel lines of relatively greater opacity than the depressions between the ridges.

72. The multi-layer secured card according to claim 71, wherein the background includes a first pattern of evenly spaced parallel ridges oriented in a first direction and a first spatial frequency, and the latent image includes a second pattern of evenly spaced parallel ridges oriented in a second direction and a second spatial frequency.

73. The multi-layer secured card according to claim 72, wherein the first direction and the second direction are approximately perpendicular.

74. The multi-layer secured card according to claim 72, wherein the first and second spatial frequencies are different and each between 65 peaks per inch and 300 peaks per inch.

75. The multi-layer secured card according to claim 71, wherein the thickness of the inner layer at peaks of the ridges is sufficient to create an opacity through the card of approximately 50-100 percent.
